(19) United States
(12) Patent Application Publication
(10) Pub. No.: US 2017/0171690 A1
(43) Pub. Date: Jun. 15, 2017

(54) METHOD FOR TERMINAL-CONDITION-BASED D2D COMMUNICATION, AND APPARATUS THEREFOR IN WIRELESS COMMUNICATION SYSTEM

(71) Applicant: LG ELECTRONICS INC., Seoul (KR)

(72) Inventors: Hakseong KIM, Seoul (KR); Hanbyul SEO, Seoul (KR)

(73) Assignee: LG ELECTRONICS INC., Seoul (KR)

(21) Appl. No.: 15/327,988

(22) PCT Filed: Jul. 20, 2015
(86) PCT No.: PCT/KR2015/007501

§ 371 Date: Jan. 20, 2017

Related U.S. Application Data
(60) Provisional application No. 62/026,693, filed on Jul. 20, 2014.

(51) Int. Cl. H04W 4/00; H04W 24/02

(52) U.S. Cl. CPC H04W 4/005; H04W 24/02; H04W 88/02

(57) ABSTRACT

Disclosed are a method for terminal-condition-based device-to-device (D2D) communication and an apparatus therefor in a wireless communication system. Specifically, the method for a terminal to carry out terminal-condition-based D2D communication in a wireless communication system supporting D2D communication comprises the steps of: a terminal determining a terminal condition indicating the condition to which self is subject; determining the D2D signal properties on the basis of the terminal condition; and transmitting the D2D signal on the basis of the D2D signal properties.

### TECHNICAL FIELD

The present invention relates to a wireless communication system, and more particularly, to a method for a user equipment (UE)-condition-based device to device (D2D) communication and apparatus therefor in a wireless communication system.

### BACKGROUND ART

A mobile communication system has been developed to provide a voice service while guaranteeing activity of a user. However, the mobile communication system extends an area up to a data service as well as a voice and at present, a short phenomenon of a resource is caused due to an explosive increase of traffic and uses require a higher-speed service, and as a result, a more developed mobile communication system is required.

Requirements of a next-generation mobile communication system largely need to support accommodation of explosive data traffic, an epochal increase of transmission rate per user, accommodation of the significantly increased number of connection devices, very low end-to-end latency, and high energy efficiency. To this end, various technologies have been researched, which include dual connectivity, massive multiple input multiple output (MIMO), in-band full duplex, non-orthogonal multiple access (NOMA), super wideband supporting, device networking, and the like.

### DISCLOSURE

### Technical Problem

An object of the present invention is to propose a method for more accurately understand a situation faced by a UE in a wireless communication supporting a device to device (D2D) communication, more particularly, a vehicle to everything (V2X) communication.

Another object of the present invention is to propose a method of informing neighbor UEs of a situation faced by a UE itself in a wireless communication system supporting a D2D communication, more particularly, a V2X communication.

Further another object of the present invention is to propose a method of selecting a signal from a UE facing a specific situation and receiving the selected signal in a wireless communication system supporting a D2D communication, more particularly, a V2X communication.

Technical objects of the present invention are not limited to the above-described object and other technical objects that have not been described above will become evident to those skilled in the art from the following description.

### Technical Solution

In an aspect of the present invention, a method of performing, by a user equipment (UE), a Device to Device (D2D) communication based on a UE condition in a wireless communication system supporting the D2D communication includes determining, by the UE, a UE condition indicating a situation faced by the UE, determining an attribute of a D2D signal depending on the UE condition, and transmitting the D2D signal based on the attribute of the D2D signal.

In another aspect of the present invention, a UE for performing a D2D (Device to Device) communication in a wireless communication system supporting the D2D communication includes a radio frequency (RF) unit for transmitting/receiving a wireless signal, and a processor, wherein the processor is configured to determine a UE condition indicating a situation faced by the UE, determine an attribute of a D2D signal depending on the UE condition, and transmit the D2D signal based on the attribute of the D2D signal.

Preferably, the UE condition may include whether a user of the UE is in an on-boarding status.

Preferably, if a random access procedure with the UE mounted on the vehicle is successfully completed, it may be determined that the user is in the on-boarding status.

Preferably, the method may further include displaying, based on an intensity of a signal received from a UE mounted on a neighbor vehicle, a list of UEs having transmitted the signal, wherein if the UE receives a selection of a specific UE from a list of the UEs from the user, it may be determined that the user is in the on-boarding status on the vehicle having the selected UE mounted thereon.

Preferably, if a signal received from a UE mounted on a neighbor vehicle is maintained with a predetermined intensity for a predetermined time, it may be determined that the user is in the on-boarding status on the vehicle having the UE having transmitted the signal mounted thereon.

Preferably, the attribute of the D2D signal may include at least one of a sequence index of the D2D signal, a resource area to which the D2D signal is mapped, a message content of the D2D signal, a hopping pattern of the D2D signal, a structure of sequence of a reference signal related to the D2D signal, or a sequence of a reference signal related to the D2D signal.

Preferably, a sequence set of different D2D signals may be defined per UE condition, and a sequence of the D2D signal may be selected within a specific sequence set corresponding to the UE condition.

Preferably, a different UE identifier (ID) set may be defined per UE condition, and a UE ID selected within a specific UE ID set corresponding to the UE condition may be included in the D2D signal and transmitted.

Preferably, when the UE is allocated a plurality of UE IDs, a specific UE ID may be selected from the allocated plurality of UE IDs depending on the UE condition.

Preferably, when the UE is allocated a plurality of UE IDs, a multiplexing pattern in a frequency or time domain of D2D signal including each UE ID depending on the UE condition may be determined.

Preferably, when the user of the UE is in an on-boarding status, a combination ID of the selected UE ID and a vehicle ID may be included in the D2D signal and transmitted.

Preferably, the combined ID may be generated by a connection of the UE ID and the vehicle ID, by a connection of a part of the UE ID and a part of the vehicle ID, by masking a CRC (Cyclic Redundancy Check) of the UE ID or the vehicle ID with a different ID, by bit operation of the UE ID and the vehicle ID, or by using a part or a whole of the vehicle ID or the UE ID as a seed of another ID generation.

### Advantageous Effects

According to the embodiments of the present invention, the situation faced by a UE may be more accurately understood.

Furthermore, according to the embodiments of the present invention, the situation faced by a UE may be more accurately notified to neighbor UEs based on a D2D signal.

Further, according to the embodiments of the present invention, only the signal or a desired UE may be reduced or reception of an unnecessary signal may be minimized by more accurately understanding the situation faced by a UE.

The technical effects of the present invention are not limited to the above-described effects and other technical effects that have not been described above will be evidently understood by those skilled in the art from the following description.

### DESCRIPTION OF DRAWINGS

In order to help understanding of the present invention, the accompanying drawings which are included as a part of the Detailed Description provide embodiments of the present invention and describe the technical features of the present invention together with the Detailed Description.

FIG. 1 illustrates an M2M system according to an ETSI technical standard to which the present invention can be applied.

FIG. 2 illustrates one example of a network structure of an evolved universal terrestrial radio access network (E-UTRAN) to which the present invention can be applied.

FIG. 3 illustrates physical channels and a view showing physical channels used for in the 3GPP LTE/LTE-A system to which the present invention can be applied.

FIG. 4 illustrates a structure of a radio frame in the wireless communication system to which the present invention can be applied.

FIG. 5 is a diagram illustrating a resource grid for one downlink slot in the wireless communication system to which the present invention can be applied.

FIG. 6 illustrates a structure of a downlink subframe in the wireless communication system to which the present invention can be applied.

FIG. 7 illustrates a structure of an uplink subframe in the wireless communication system to which the present invention can be applied.

FIG. 8 is a diagram for describing the contention-based random access procedure in the wireless communication system to which the present invention can be applied.

FIG. 9 is a diagram for describing the non-contention-based random access procedure in the wireless communication system to which the present invention can be applied.

FIG. 10 conceptually illustrates a device to device (D2D) communication in a wireless communication system to which the present invention may be applied.

FIG. 11 illustrates an example of various scenarios of a D2D communication to which the method proposed in the present specification may be applied.

FIG. 12 illustrates a distributed discovery resource allocation scheme in a wireless communication system to which the present invention may be applied.

FIG. 13 illustrates a method of transmitting and receiving a signaling for a direct D2D communication in a wireless communication system to which the present invention may be applied.

FIG. 14 illustrates a method of transmitting downlink control information for direct D2D communication in a wireless communication system to which the present invention may be applied.

FIG. 15 illustrates a user interface when implementing a method of collecting a D2D ID according to an embodiment of the present invention.

FIG. 16 illustrates a method of collecting a D2D ID according to an embodiment of the present invention.

FIG. 17 illustrates a method of collecting a D2D ID according to an embodiment of the present invention.

FIG. 18 illustrates a method of D2D communication based on a UE condition according to an embodiment of the present invention.

FIG. 19 illustrates a D2D communication based on a UE condition according to an embodiment of the present invention.

FIG. 20 illustrates a D2D communication based on a UE condition according to an embodiment of the present invention.

FIG. 21 illustrates a block diagram of a wireless communication apparatus according to an embodiment of the present invention.

FIG. 22 is a block diagram of a UE according to another embodiment of the present invention.

### MODE FOR INVENTION

Some embodiments of the present invention are described in detail with reference to the accompanying drawings. A detailed description to be disclosed along with the accompanying drawings are intended to describe some embodiments of the present invention and are not intended to describe a sole embodiment of the present invention. The following detailed description includes more details in order to provide full understanding of the present invention. However, those skilled in the art will understand that the present invention may be implemented without such more details.

In some cases, in order to avoid that the concept of the present invention becomes vague, known structures and devices are omitted or may be shown in a block diagram form based on the core functions of each structure and device.

In this specification, a base station has the meaning of a terminal node of a network over which the base station directly communicates with a device. In this document, a specific operation that is described to be performed by a base station may be performed by an upper node of the base station according to circumstances. That is, it is evident that in a network including a plurality of network nodes including a base station, various operations performed for communication with a device may be performed by the base station or other network nodes other than the base station. The base station (BS) may be substituted with another term, such as a fixed station, a Node B, an eNB (evolved-NodeB), a Base Transceiver System (BTS), or an access point (AP). Furthermore, the device may be fixed or may have mobility and may be substituted with another term, such as User Equipment (UE), a Mobile Station (MS), a User Terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, or a Device-to-Device (D2D) device.

Hereinafter, downlink (DL) means communication from an eNB to UE, and uplink (UL) means communication from UE to an eNB. In DL, a transmitter may be part of an eNB, and a receiver may be part of UE. In UL, a transmitter may be part of UE, and a receiver may be part of an eNB.

Specific terms used in the following description have been provided to help understanding of the present invention, and the use of such specific terms may be changed in various forms without departing from the technical sprit of the present invention.

The following technologies may be used in a variety of wireless communication systems, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and Non-Orthogonal Multiple Access (NOMA). CDMA may be implemented using a radio technology, such as Universal Terrestrial Radio Access (UTRA) or CDMA2000. TDMA may be implemented using a radio technology, such as Global System for Mobile communications (GSM)/General Packet Radio Service (GPRS)/Enhanced Data rates for GSM Evolution (EDGE). OFDMA may be implemented using a radio technology, such as Institute of Electrical and Electronics Engineers (IEEE) 802.11 (Wi-Fi), IEEE 802.16 (WiMAX), IEEE 802.20, or Evolved UTRA (E-UTRA). UTRA is part of a Universal Mobile Telecommunications System (UMTS). 3rd Generation Partnership Project (3GPP) Long Term Evolution (LTE) is part of an Evolved UMTS (E-UMTS) using evolved UMTS Terrestrial Radio Access (E-UTRA), and it adopts OFDMA in downlink and adopts SC-FDMA in uplink. LTE-Advanced (LTE-A) is the evolution of 3GPP LTE.

Embodiments of the present invention may be supported by the standard documents disclosed in at least one of ETSI (European Telecommunications Standards Institute), IEEE 802, 3GPP, and 3GPP2, that is, radio access systems. That is, steps or portions that belong to the embodiments of the present invention and that are not described in order to clearly expose the technical spirit of the present invention may be supported by the documents. Furthermore, all terms disclosed in this document may be described by the standard documents.

A concept and a technology in which an object is connected to a network or information is shared by configuring a communication network among objects by using a communication device attached to the object may be called machined to machine communication.

The ETSI calls the machine to machine communication as Machine-to-Machine (M2M) and the M2M is defined as communication among two or more objects in which human direct intervention is not particularly required.

In the specification, an M2M server calls a server for M2M communication and calls a fixed station or a mobile station. The M2M server may exchange data and control information by communicating with M2M devices and/or other M2M server. Further, in the present invention, an M2M gateway calls a device that serves as a connection point which enters another network from one network when a network connected with the M2M device and a network connected with the M2M server are different from each other.

In addition, in the specification, a term “entity” may be used to call hardware such as the M2M device, the M2M gateway, and the M2M server or used to call software components of an M2M application layer and an M2M (common) service layer described below.

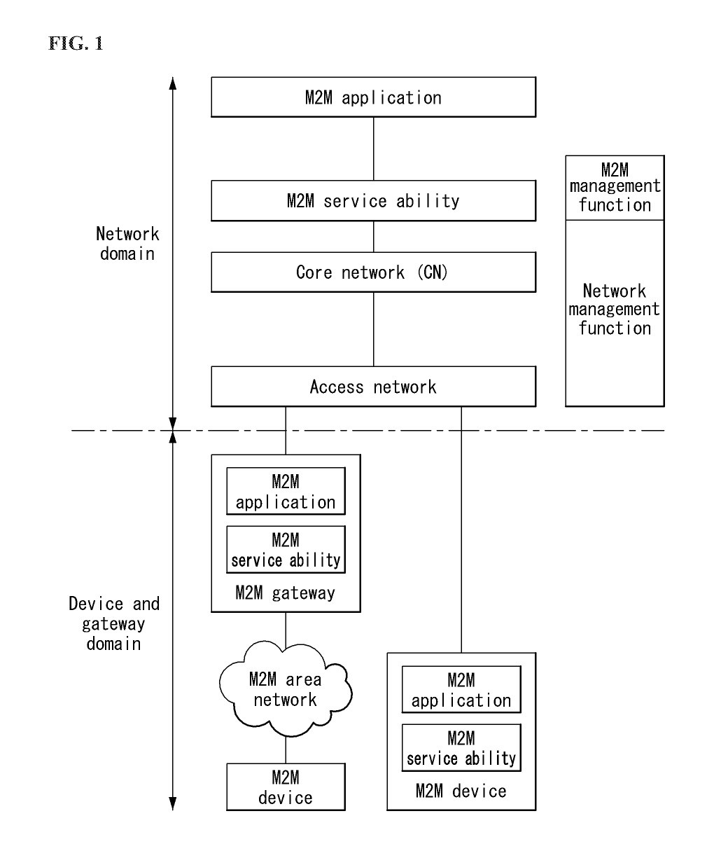

FIG. 1 illustrates an M2M system according to an ETSI technical standard to which the present invention can be applied.

An M2M system according to an ETSI TS M2M technical standard defines a common M2M service framework for various M2M applications. The M2M applications may call software components that implement M2M service solutions such as e-Health, City Automation, Connected Consumer, and Automotive. In the M2M system, functions commonly required for implementing the various M2M applications may be provided and the commonly required functions may be called an M2M service or an M2M common service. When the M2M common service is used, the M2M application may be easily implemented without reconfiguring a basic service framework for each M2M application.

The M2M service is provided in the form of a service capability (SC) and the M2M application may access the SC through an open interface and use the M2M service provided by the SC. The SC may be a set of functions of the M2M service, which may be used when the M2M application is provided on the service framework. A service capability (SC) entity and a service capability (SC) layer may be collectively called the SC.

The SC may be expressed as xSC. Herein, x may be expressed as one of N, G, and D and represents at which network (and/or server), gateway, or device the SC is present. For example, the NSC represents the SC which is present on the network and/or server and the GSC represents the SC which is present on the gateway.

The M2M application may be present on the network, the gateway, or the device.

The M2M application which is present on the network or present in direct connection with the server is called an M2M network application and may be briefly represented by a network application (NA). For example, the NA is software implemented in direct connection to the server and may serve to communicate with and manage the M2M gateway or the M2M device.

The M2M application which is present on the device is called an M2M device application and may be briefly expressed by a device application (DA). For example, the DA is software driven in the M2M device and may transfer sensor information, and the like to the NA.

The M2M application which is present on the gateway is called an M2M gateway application and may be briefly expressed by a gateway application (GA). For example, the GA may serve to manage an M2M gateway and provide the service capability (SC) to the DA. An application entity (AE) and an application layer may be collectively called the M2M application.

Referring to FIG. 1, a high level architecture for the M2M may be divided into a network domain and a device and gateway domain.

The network domain may be constituted by an access network, a core network, an M2M service capability (SC), an M2M application, network management functions, and an M2M management function.

The access network is an entity that enables the M2M device and the gateway domain to communicate with the core network. Examples of the access network include xDSL (Digital Subscriber Line), HFC (Hybrid Fiber Coax), a satellite, GERAN, UTRAN, eUTRAN, Wireless LAN, WiMAX, and the like.

The core network is an entity that provides functions including Internet protocol (IP) connection, service and network control, interconnection, roaming, and the like. The core network includes a 3rd Generation Partnership Project (3GPP) core network, an ETSI Telecommunications and Internet converged Services and Protocols for Advanced Networking (TISPAN) core network, a 3GPP2 core network, and the like.

Therefore, in an example of FIG. 1, the core network and the access network provides connections among the respective entities rather than performing an M2M function. M2M communication may be performed among the M2M SCs in the network domain and the device and gateway domain through the core network and the access network and the M2M application of each domain may transmit and receive a signal or information through the M2M SC of each domain.

The M2M SC may provide an M2M common service function (CSF) which may be shared in multiple M2M network applications and exposes the M2M service through the open interface to allow the M2M applications to use the M2M service. An M2M SC entity may be appreciated as one instance of a common service function (CSF) and provides a subset of the common service functions (CSFs) which may be used and shred by the M2M applications. An M2M service capability layer (SCL) may represent a layer including the M2M SC entity.

The M2M application is an entity that may operate service logic and use the M2M SC through the open interface. The M2M application layer may represent a layer including the application and related operational logic.

The network management functions are constituted by functions required for managing the core network and the access network. The functions include provisioning, supervision, fault management, and the like.

The M2M management function is constituted by a function required for managing the M2M SC in the network domain. A specific M2M SC is used to manage the M2M device and the gateway. A set of the M2M management function includes a function for an M2M service bootstrap. The function is called an M2M service bootstrap function (MSBF) and is implemented in an appropriate server. A role of the MSBF enables a bootstrap of permanent M2M service layer security credential in the M2M SC in the M2M device (alternatively, the M2M gateway) and the network domain. Permanent security credential bootstrapped by using the MSBF (e.g., an M2M root key) is stored at a safe position called an M2M authentication server (MAS). The server may be an AAA server. The MSBF may be included in the MAS and further, may communicate with the MAS through an appropriate interface (e.g., a diameter when the MAS is AAA). The corresponding permanent security credential established in a D/G M2M node during the bootstrapping is stored in a secured environment domain of the D/G M2M node.

The device and gateway domain is constituted by the M2M device, an M2M area network, and the M2M gateway.

The M2M device is an entity that operates the M2M device application through the M2M SC. The M2M device may include the M2M application and/or the M2M SC.

The M2M device may be connected with the network domain through the access network (that is, communicate with the M2M server of the network domain). The M2M device performs procedures including registration, authentication, authorization, management, and provisioning with the network domain. The M2M device may provide the service in connection with other devices (e.g., a legacy device, and the like) hidden from the network domain.

The M2M device may be connected with the network domain through the M2M gateway (that is, communicate with the M2M server of the network domain). When the M2M device is connected with the network domain through the M2M gateway, the M2M gateway operates like a proxy. One example of a proxy procedure of the M2M gateway corresponds to the authentication, the authorization, the management, and the provisioning. The M2M device is connected with the M2M gateway by using the M2M area network.

The M2M device may be connected to the network domain through multiple M2M gateways.

The M2M area network provides connectivity between the M2M device and the M2M gateway. In this case, the network between the M2M gateway and the M2M server and the network between the M2M device and the M2M gateway may be different from each other. For example, the M2M area network may be implemented by using a personal area network (PAN) technology such as IEEE802.15.1, Zigbee, Bluetooth, IETF ROLL, or ISA100.11a and a local network technology such as power line communication (PLC), M-BUS, wireless M-BUS, KNX, or the like.

The M2M gateway is an entity that manages the M2M application through the M2M SC and provides the service to the M2M application. The M2M gateway may include the M2M application and/or the M2M SC. The M2M gateway may represent an entity having a gateway function among the M2M devices.

The M2M gateway may serve as the proxy between the M2M device and the network domain and provide the service in connection with other devices (e.g., the legacy device, and the like) hidden from the network domain. For example, the M2M gateway may operate an application that collects and handles various information (e.g., information from a sensor and a contextual parameter).

An M2M system architecture illustrated in FIG. 1 is just an example and a name of each entity may vary. For example, in a system (called an oneM2M system) according to a oneM2M technical standard, the M2M SC may be called an M2M common service entity (CSE) and a service capability layer (SCL) may be called a common service layer (CSL). Further, the M2M application may be called the application entity (AE) and the M2M application layer may be briefly called the application layer. Similarly, the name of each domain may also vary. For example, in the oneM2M system, the network domain may be called an infrastructure domain and the device and gateway domain may be called a field domain.

As illustrated in FIG. 1, the M2M system may be appreciated as a layer structure including the M2M application layer and the M2M SC layer for the M2M communication.

Meanwhile, even in the 3GPP, a standardization work is progressed by using a name called machine type communications with respect to M2M communication. In the 3GPP, the MTC is defined in the form of data communication which one or more objects are concerned with, in which human intervention is not particularly required.

In the specification, the MTC may be appreciated as the same meaning as the M2M communication, Internet of things (IoT), and device-to-device (D2D).

Hereinafter, in order to clearly describe the present invention, 3GPP LTE/LTE-A is primarily described, but a technical feature of the present invention is not limited thereto.

General System to which Present Invention can be Applied

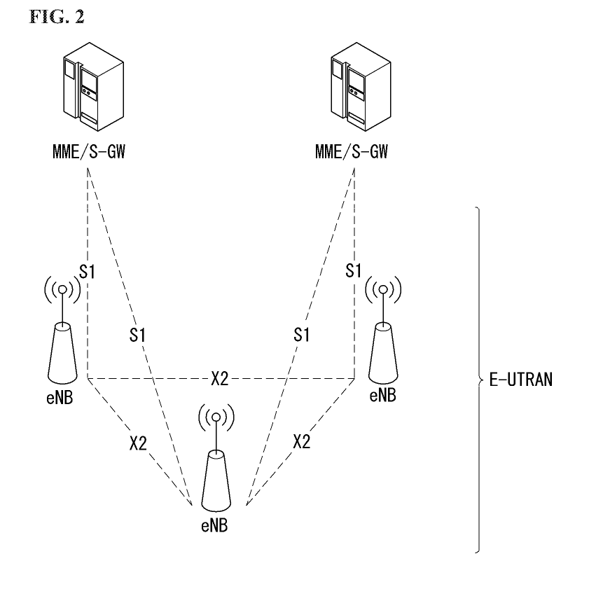

FIG. 2 illustrates an example of the network structure of E-UTRAN (evolved universal terrestrial radio access network) to which the present invention may be applied.

An E-UTRAN system is an advanced version of the existing UTRAN system, and may be a 3GPP LTE/LTE-A system, for example. E-UTRAN consists of eNBs that provide a control plane protocol and a user plane protocol to UEs, and the eNBs are connected via the X2 interface. The X2 user plane interface X2-U is defined between the eNBs. The X2-U interface provides non-guaranteed delivery of user plane PDUs (packet data units). The X2 control plane interface X2-CP is defined between two neighbor eNBs. The X2-CP performs the following functions: context transfer between eNBs, control of user plane tunnels between a source eNB and a target eNB, transfer of handover-related messages, uplink load management and the like. An eNB is connected to user equipment UE through a radio interface and is connected to an Evolved Packet Core (EPC) through the S1 interface. The S1 user plane interface (S1-U) is defined between the eNB and the serving gateway (S-GW). The SI control plane interface (S1-MME) is defined between the eNB and the MME (Mobility Management Entity). The S1 interface performs the following functions: EPS (Enhanced Packet System) Bearer Service Management function, NAS (Non-Access Stratum) Signaling Transport function, Network Sharing Function, MME Load balancing Function and the like. The S1 interface supports many-to-many relations between eNBs and MMEs/S-GWs.

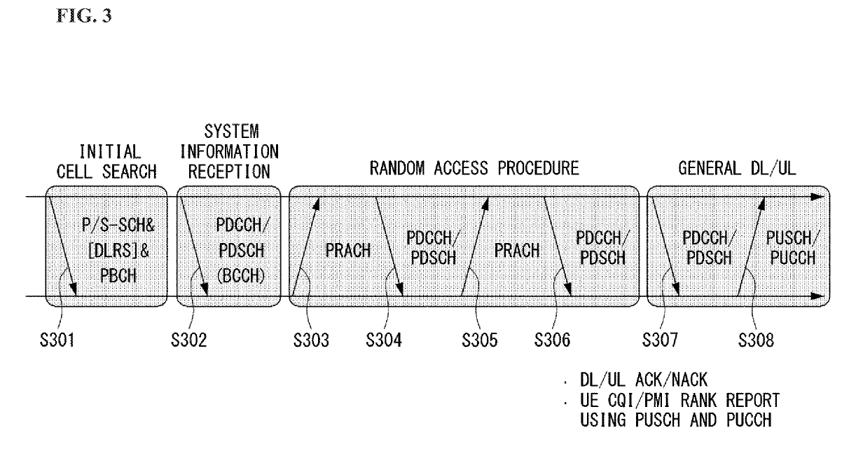

FIG. 3 illustrates physical channels and a view showing physical channels used for in the 3GPP LTE/LTE-A system to which the present invention can be applied.

When a UE is powered on or when the UE newly enters a cell, the UE performs an initial cell search operation such as synchronization with a BS in step S301. For the initial cell search operation, the UE may receive a Primary Synchronization Channel (P-SCH) (or Primary Synchronization Signal (PSS)) and a Secondary Synchronization Channel (S-SCH) (or Secondary Synchronization Signal (SSS)) from the BS so as to perform synchronization with the BS, and acquire information such as a cell ID.

Thereafter, the UE may receive a physical broadcast channel (PBCH) from the BS and acquire broadcast information in the cell. Meanwhile, the UE may receive a Downlink Reference signal (DL RS) in the initial cell search step and confirm a downlink channel state.

The UE which completes the initial cell search may receive a Physical Downlink Control Channel (PDCCH) and a Physical Downlink Shared Channel (PDSCH) corresponding to the PDCCH, and acquire more detailed system information in step S302.

Thereafter, the UE may perform a random access procedure in steps S303 to S306, in order to complete the access to the BS. For the random access procedure, the UE may transmit a preamble via a Physical Random Access Channel (PRACH) (S303), and may receive a message in response to the preamble via the PDCCH and the PDSCH corresponding thereto (S304). In contention-based random access, a contention resolution procedure including the transmission of an additional PRACH (S305) and the reception of the PDCCH and the PDSCH corresponding thereto (S306) may be performed.

The UE which performs the above-described procedure may then receive the PDCCH/PDSCH (S307) and transmit a Physical Uplink Shared Channel (PUSCH)/Physical Uplink Control Channel (PUCCH) (S308), as a general uplink/downlink signal transmission procedure.

Control information transmitted from the UE to the BS is collectively referred to as uplink control information (UCI). The UCI includes hybrid automatic repeat and request acknowledgement/negative-acknowledgement (HARQ ACK/NACK), scheduling request (SR), channel quality information (CQI), preceding matrix indicator (PMI), rank indication (RI), etc. In the embodiments of the present invention, CQI and/or PMI are also referred to as channel quality control information.

In general, although a UCI is periodically transmitted via a PUCCH in the LTE system, this may be transmitted through a PUSCH if control information and traffic data are simultaneously transmitted. In addition, a UCI may be aperiodically transmitted via a PUSCH according to a network request/instruction.

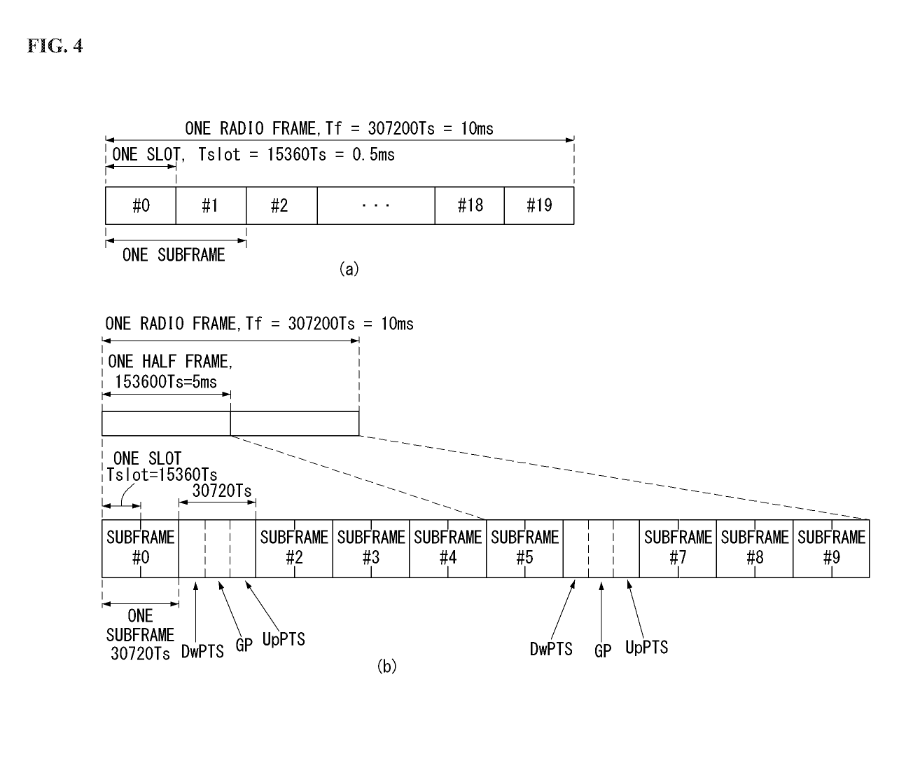

FIG. 4 illustrates the structure of a radio frame in a wireless communication system to which an embodiment of the present invention can be applied.

3GPP LTE/LTE-A support a radio frame structure type 1 which may be applicable to Frequency Division Duplex (FDD) and a radio frame structure which may be applicable to Time Division Duplex (TDD).

FIG. 4(a) illustrates the radio frame structure type 1. A radio frame consists of 10 subframes. One subframe consists of 2 slots in a time domain. The time taken to send one subframe is called a Transmission Time Interval (TTI). For example, one subframe may have a length of 1 ms, and one slot may have a length of 0.5 ms.

One slot includes a plurality of Orthogonal Frequency Division Multiplexing (OFDM) symbols in the time domain and includes a plurality of Resource Blocks (RBs) in a frequency domain. In 3GPP LTE, OFDM symbols are used to represent one symbol period because OFDMA is used in downlink. An OFDM symbol may be called one SC-FDMA symbol or symbol period. An RB is a resource allocation unit and includes a plurality of contiguous subcarriers in one slot.

FIG. 4(b) illustrates the frame structure type 2. The radio frame structure type 2 consists of 2 half frames. Each of the half frames consists of 5 subframes, a Downlink Pilot Time Slot (DwPTS), a Guard Period (GP), and an Uplink Pilot Time Slot (UpPTS). One subframe consists of 2 slots. The DwPTS is used for initial cell search, synchronization, or channel estimation in UE. The UpPTS is used for channel estimation in an eNB and to perform uplink transmission synchronization with UE. The guard period is an interval in which interference generated in uplink due to the multi-path delay of a downlink signal between uplink and downlink is removed.

The structure of a radio frame is only one example. The number of subcarriers included in a radio frame or the number of slots included in a subframe and the number of OFDM symbols included in a slot may be changed in various ways.

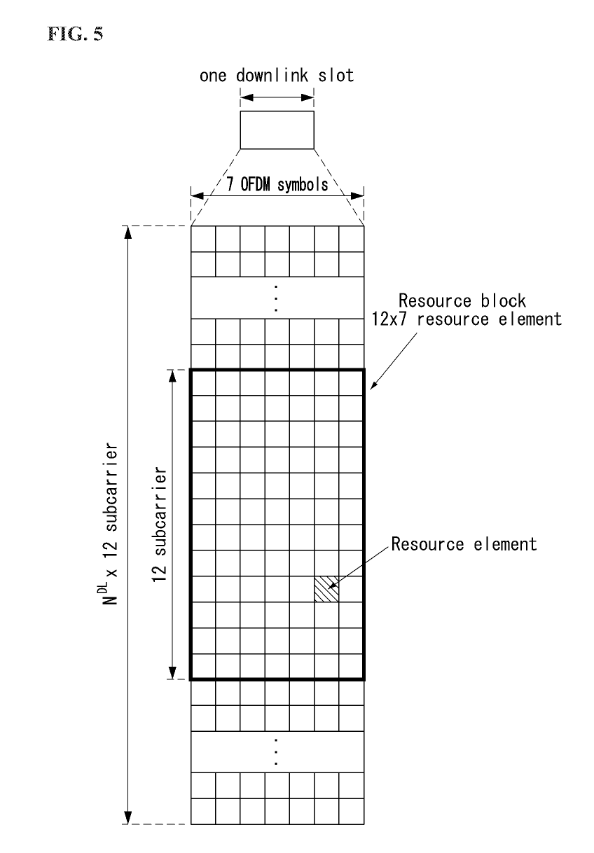

FIG. 5 is a diagram illustrating a resource grid for one downlink slot in a wireless communication system to which an embodiment of the present invention can be applied.

Referring to FIG. 5, one downlink slot includes a plurality of OFDM symbols in a time domain. It is described herein that one downlink slot includes 7 OFDMA symbols and one resource block includes 12 subcarriers for exemplary purposes only, and the present invention is not limited thereto.

Each element on the resource grid is referred to as a resource element, and one resource block (RB) includes 12×7 resource elements. The number of RBs NADL included in a downlink slot depends on a downlink transmission bandwidth.

The structure of an uplink slot may be the same as that of a downlink slot.

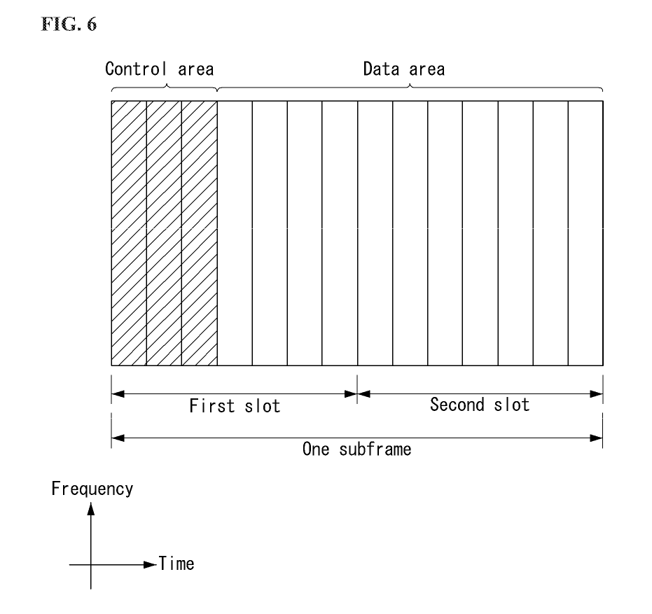

FIG. 6 illustrates the structure of a downlink subframe in a wireless communication system to which an embodiment of the present invention can be applied.

Referring to FIG. 6, a maximum of three OFDM symbols located in a front portion of a first slot of a subframe correspond to a control region in which control channels are allocated, and the remaining OFDM symbols correspond to a data region in which a physical downlink shared channel (PDSCH) is allocated. Downlink control channels used in 3GPP LTE include, for example, a physical control format indicator channel (PCFICH), a physical downlink control channel (PDCCH), and a physical hybrid-ARQ indicator channel (PHICH).

A PCFICH is transmitted in the first OFDM symbol of a subframe and carries information about the number of OFDM symbols (i.e., the size of a control region) which is used to transmit control channels within the subframe. A PHICH is a response channel for uplink and carries an acknowledgement (ACK)/not-acknowledgement (NACK) signal for a Hybrid Automatic Repeat Request (HARQ). Control information transmitted in a PDCCH is called Downlink Control Information (DCI). DCI includes uplink resource allocation information, downlink resource allocation information, or an uplink transmission (Tx) power control command for a specific UE group.

A PDCCH may carry information about the resource allocation and transport format of a downlink shared channel (DL-SCH) (this is also called an “downlink grant”), resource allocation information about an uplink shared channel (UL-SCH) (this is also called a “uplink grant”), paging information on a PCH, system information on a DL-SCH, the resource allocation of a high layer control message, such as a random access response transmitted on a PDSCH, a set of transmission power control commands for individual UE within specific UE group, and the activation of a Voice over Internet Protocol (VoIP), etc. A plurality of PDCCHs may be transmitted within the control region, and UE may monitor a plurality of PDCCHs. A PDCCH is transmitted on a single Control Channel Element (CCE) or an aggregation of some contiguous CCEs. A CCE is a logical allocation unit that is used to provide a PDCCH with a coding rate according to the state of a radio channel. A CCE corresponds to a plurality of resource element groups. The format of a PDCCH and the number of available bits of a PDCCH are determined by an association relationship between the number of CCEs and a coding rate provided by CCEs.

An eNB determines the format of a PDCCH based on DCI to be transmitted to UE and attaches a Cyclic Redundancy Check (CRC) to control information. A unique identifier (a Radio Network Temporary Identifier (RNTI)) is masked to the CRC depending on the owner or use of a PDCCH. If the PDCCH is a PDCCH for specific UE, an identifier unique to the UE, for example, a Cell-RNTI (C-RNTI) may be masked to the CRC. If the PDCCH is a PDCCH for a paging message, a paging indication identifier, for example, a Paging-RNTI (P-RNTI) may be masked to the CRC. If the PDCCH is a PDCCH for system information, more specifically, a System Information Block (SIB), a system information identifier, for example, a System Information-RNTI (SI-RNTI) may be masked to the CRC. A Random Access-RNTI (RA-RNTI) may be masked to the CRC in order to indicate a random access response which is a response to the transmission of a random access preamble by UE.

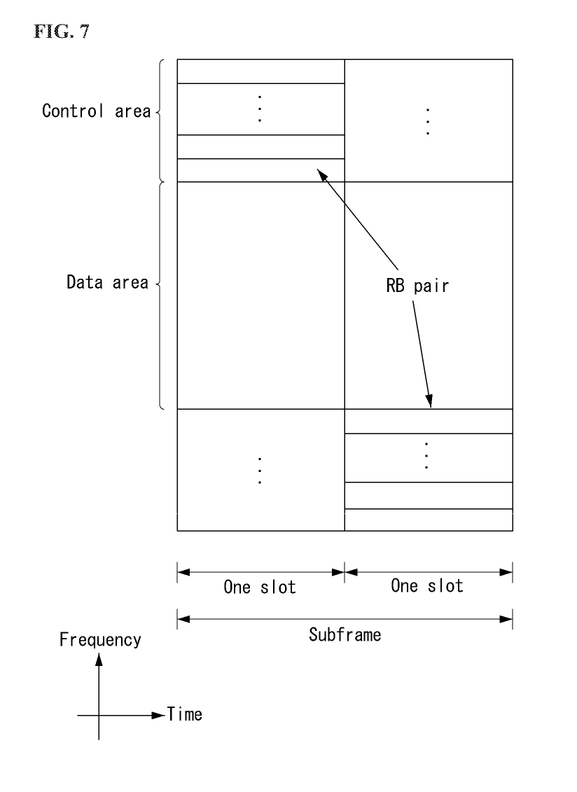

FIG. 7 illustrates the structure of an uplink subframe in a wireless communication system to which an embodiment of the present invention can be applied.

Referring to FIG. 7, the uplink subframe may be divided into a control region and a data region in a frequency domain. A physical uplink control channel (PUCCH) carrying uplink control information is allocated to the control region. A physical uplink shared channel (PUSCH) carrying user data is allocated to the data region.

A Resource Block (RB) pair is allocated to a PUCCH for one UE within a subframe. RBs belonging to an RB pair occupy different subcarriers in each of 2 slots. This is called that an RB pair allocated to a PUCCH is frequency-hopped in a slot boundary.

Random Access Procedure

Hereinafter, a random access procedure which is provided in a LTE/LTE-A system will be described.

The random access procedure is used in order for a UE to obtain the UL synchronization with an eNB or to be allocated with UL radio resource. After turning on the power of UE, the UE acquires the DL synchronization with an initial cell and receives the system information. The UE gains the information of the set of usable random access preamble and that of the radio resource which is used for the transmission of random access preamble. The radio resource that is used for the transmission of random access preamble may be specified as the combination of at least one subframe index and an index on the frequency domain. The UE transmits the random access preamble that is randomly selected from the set of random access preamble, and the eNB that receives the random access preamble transmits the timing alignment (TA) value for the UL synchronization to the UE through the random access response. The UE acquires the UL synchronization in this way.

The random access procedure shows common in frequency division duplex (FDD) and time division duplex (TDD). The random access procedure is irrelevant to the cell size, and the number of serving cell in case of the carrier aggregation being configured.

First, the following shows the case that a UE performs the random access procedure.
In case that the UE performs an initial access in a RRC idle state without any RRC connection to an eNB
In case that the UE performs a RRC connection re-establishment procedure
In case that the UE tries to an initial access to a target cell in a handover procedure
In case that an random access procedure is requested by the command from eNB
In case that there is any data that is going to be transmitted to UL in a non-synchronized condition during the RRC connected state
In case that there is any data that is going to be transmitted to UL in a non-synchronized condition and in a condition that the radio resource designated for requesting the radio resource is not allocated during the RRC connected state
In case that the UE positioning is performed in a condition that timing advance is required during the RRC connected state
In case that restoration procedure is performed in a radio link failure or handover failure

In 3GPP Rel-10, it is considered that the timing advance (TA) value that is applicable to a specific cell (for example, PCell) in a wireless access system that supports the carrier aggregation is applied to a plurality of cells in common. However, the UE may aggregate a plurality of cells that are included in different frequency bands (that is, spaced apart on the frequency domain) or a plurality of cells that have different propagation characteristics. In addition, in case of a specific cell, for the extension of coverage or the removal of coverage hole, in a condition that small cells (or a secondary eNB (SeNB)) such as a remote radio header (RRH) (that is, repeater), a femto cell, or a pico cell, etc. is arranged in the cell, the UE performs a communication with the eNB (that is, macro eNB), in case of performing the communication with the secondary eNB through another cell, a plurality of cell may have different characteristics of the propagation delay. In this case, if the UL transmission is performed in a way that one TA value is commonly applied to a plurality of cells, it may profoundly affect the synchronization of UL signals that are transmitted on a plurality of cells. Accordingly, it may be desired to have a plurality of TAs in a condition of the CA that a plurality of cells are aggregated, and in 3GPP Rel-11, considered to allocate the TA independently in a specific cell group unit for supporting multiple TA. It is referred to as TA group (TAG), the TAG may include one or more cell(s), and the same TA may be commonly applied in one more cell(s) that are included in the TAG. For supporting the multiple TA, the MAC TA command control element is configured with 2-bit TAG ID and 6-bit TAG command field.

The UE on which a carrier aggregation is configured performs the random access procedure in case that the random access procedure previously described is required in connection with PCell. In case of TAG (that is, primary TAG (pTAG)) to which PCell belongs, the TA, which is determined based on PCell same as the existing case, or regulated through the random access procedure that accompanies PCell, may be applied to all the cells within the pTAG. Meanwhile, in case of TAG (that is, secondary TAG (sTAG)) that is configured with SCells only, the TA, which is determined based on a specific SCell within sTAG, may be applied to all the cells within the relevant sTAG, and in this time, the TA may be acquired through the random access procedure by being initiated by the eNB. Particularly, the SCell in the sTAG is set to be RACH resource, and the eNB requests a RACH access in SCell for determining TA. That is, the eNB initiates the RACH transmission on the SCells by PDCCH order that is transmitted from PCell. The response message for the SCell preamble is transmitted through PCell by using RA-RNTI. The TA that is determined based on SCell that successfully completes the random access may be applied to all the cells in the relevant sTAG by the UE. Like this, the random access procedure may be performed in SCell as well in order to acquire timing alignment of the sTAG to which the relevant SCell belongs.

The LTE/LTE-A system provides both of the contention-based random access procedure that the UE randomly selects to use one preamble in a specific set and the non-contention-based random access procedure that the eNB uses the random access preamble that is allocated to a specific UE. However, the non-contention-based random access procedure may be used only for the handover procedure previously described, specific case of being requested by the order of eNB, the UE positioning and/or the timing advance alignment for the sTAG. After the random access procedure is completed, a normal UL/DL transmission is made.

In the meantime, relay node (RN) also supports both of the contention-based random access procedure and the non-contention-based random access procedure. When the relay node performs the random access procedure, the RN suspends the subframe configuration at the moment. That is, it means that the RN subframe configuration is temporarily terminated. Then, the RN subframe configuration is reinitiated at the time when the random access procedure has been successfully completed.

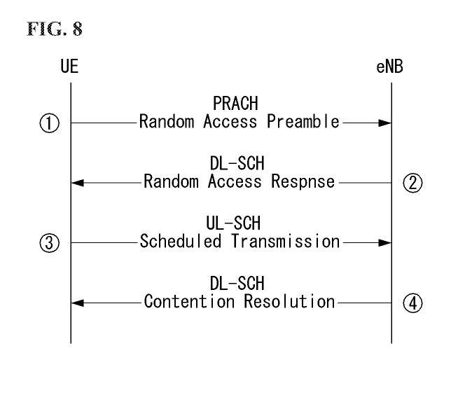

FIG. 8 is a diagram for describing the contention-based random access procedure in the wireless communication system to which the present invention can be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The random access preamble is transmitted by 6 bits in the RACH transmission channel, and the 6-bit consists of 5-bit random identity for identifying the RACH transmitted UE and the rest 1-bit (for example, indicating the size of msg 3) for representing additional information.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the relevant UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary C-RNTI (TC-RNTI), and time alignment command (TAC). The TAC is the information indicating a time synchronization value that is transmitted by the eNB in order to maintain the UL time alignment. The UE updates the UL transmission timing using the time synchronization value. On the update of the time synchronization value, the UE initiates or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC PDU and the MAC PDU may be delivered through PDSCH. It is desirable to include the information of UE that is to receive the PDSCH, frequency and the time information of the PDSCH radio resource, and transmission type of the PDSCH, etc in the PDCCH. As described above, if succeeding in detecting the PDCCH that is transmitted to the UE itself, the UE may receive properly the random access response that is transmitted to the PDSCH according to the PDCCH information.

The random access response window represents the maximum time section when the UE that has transmitted the preamble is waiting for the random access response message. The random access response window has the length of ‘ra-ResponseWindowSize’, which starts from the subframe after 3 subframes from the last subframe in which the preamble is transmitted. That is, the UE is waiting for receiving the random access response during the random access window secured after 3 subframes from the subframe in which the preamble transmission is completed. The UE may acquire the random access window size (‘ra-ResponseWindowsize’) parameter value through the system information, and the random access window size may be determined as a value from 2 to 10.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

As described above, the reason why the random access preamble index is needed in the random access response is that one random access response may include the random access response information for one or more UEs, and so there is required an index to instruct for which UE the above UL grant, TC-RNTI, and TAC are available.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB. In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. In the content based random access procedure, the eNB may not identify which UEs perform the random access procedure, but the eNB is required to identify the UE in order to solve the collision later on.

There are two ways how to include the identifier of UE. The first method is that the UE transmits the C-RNTI of its own through the UL transmission signal corresponding to the UL grant, if the UE has a valid C-RNTI that is already allocated by the relevant cell before the random access procedure. Meanwhile, if the UE has not been allocated a valid C-RNTI before the random access procedure, the UE transmits including unique identifier of its own (for example, S-TMSI or random number). Normally the above unique identifier is longer than C-RNTI. For the transmission on the UL SCH, the UE-specific scrambling is used. However, if the UE has not been allocated C-RNTI yet, the scrambling is not based on the C-RNTI but uses TC-RNTI that is received from the random access response instead. If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the relevant UE. Herein, the 4 message may correspond to the RRC connection setup message including C-RNTI.

The UE waits for the instruction of eNB in order to resolve contention after transmitting the data including the identifier of its own through the UL grant included the random access response. That is, the UE attempts the receipt of PDCCH in order to a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure has been completed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a random access procedure has been completed. The UE acquires C-RNTI through the 4 message, and after that, the UE and network are to transmit and receive a UE-specific message by using the C-RNTI.

The following is a description of the way how to resolve a collision in the random access.

The reason why a collision is occurred in performing the random access is that the number of random access preamble is limited basically. That is, it is not available that the eNB assigns a unique random access preamble for the UE to all the UEs, and the UE should randomly select one among the common random access preambles and transmit. According to this, a case is occurred that two or more UEs select the identical random access preamble through the identical radio resource (PRACH resource) and transmit, but the eNB recognizes it as one random access preamble that is transmitted from one UE. Accordingly, the eNB transmits the random access response to the UE and expects that the random access response is supposed to be received by one UE. However, as described above, as there is a possibility that a collision is occurred, two or more UEs are going to receive one random access response, and according to this, each UE performs an operation by the receipt of random access response. That is, there is a problem that two or more UEs transmit different data to the same radio resource by using one UL grant included in the random access response. According to this, the data transmission might be all failed, and depending on the location of UEs or transmission power, the data of a specific UE only may be received by the eNB. In the latter case, as all of the two or more UEs assume that the data transmission of its own are succeeded, the eNB should inform the fact to the relevant UEs that they are failed in contention. That is, what to inform the fact of the failure or success in contention is referred to as contention resolution.

There are two ways of contention resolution. The one is to use the contention resolution timer, and the other is to transmit the identifier of successful UE to UEs. The former is applied to the case that the UE already has a unique C-RNTI before the random access procedure. That is, the UE that already has the C-RNTI transmits the data including the C-RNTI of itself according to the random access response and operates the contention resolution timer. And if the PDCCH information that is addressed by the C-RNTI of its own is received before the contention resolution timer is terminated, the UE judges itself to succeed in the contention and normally terminates the random access. In the contrary, if the PDCCH information that is addressed by the C-RNTI of its own is not received before the contention resolution timer is terminated, the UE judges itself to fail in the contention and renews the random access procedure, or informs the fact of failure to the higher layer. In the latter case of the ways of contention resolution, that is, the case that is to transmit the identifier of successful UE, is used for what the UE does not have a unique C-RNTI before the random access procedure. That is, in case that the UE itself does not have C-RNTI, the UE transmits including a higher identifier (S-TMSI or random number) more than the C-RNTI of data according to the UL Grant included in the random access response, and operates the contention resolution timer. In case that the data including the higher identifier of its own is transmitted to DL-SCH before the contention resolution timer is terminated, the UE judges that the random access procedure is successful. On the other hand, in case that the data including the higher identifier of its own is not transmitted to DL-SCH before the contention resolution timer is terminated, the UE judges that the random access procedure is failed.

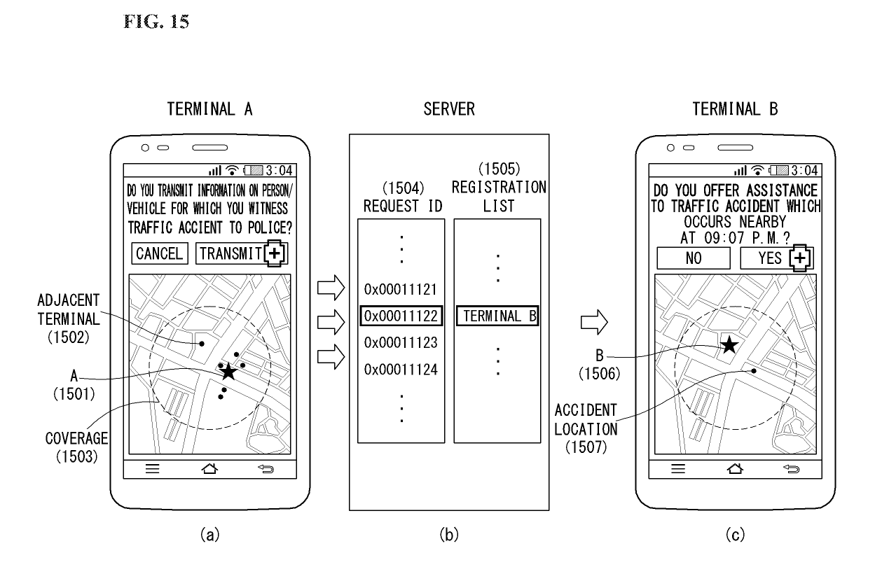

Meanwhile, the operation of the non-contention-based random access procedure, unlike the contention-based random access procedure illustrated in FIG. 15, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

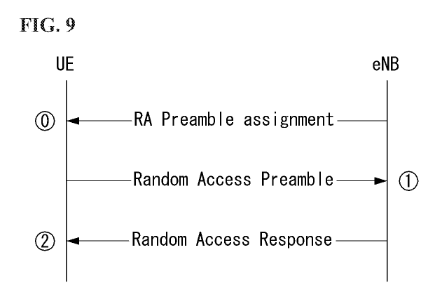

FIG. 9 is a diagram for describing the non-contention-based random access procedure in the wireless communication system to which the present invention can be applied.

(1) The Allocation of the Random Access Preamble

As described above, the non-contention-based random access procedure may be performed in order for (1) the case of handover procedure, (2) the case of being requested by the eNB command, or (3) the UE positioning and/or the timing advance alignment for sTAG. Of course, the contention-based random access procedure may be performed for the cases mentioned above.

First, it is important to receive the random access preamble that is designated and has not possibility of collision for the non-contention-based random access procedure. In case that the eNB allocates a specific random access preamble to a specific UE, the random access preamble used the relevant specific UE only and the other UEs don't use the random access preamble, and so there is not occurred a collision with other UEs. The way how to take instruction of the random access preamble is to use the handover command and PDCCH command. The UE is allocated with the random access preamble through this.

(2) Message 1 (Msg 1)

The UE, as described above, is allocated the random access preamble designated to itself and transmits the allocated preamble to the eNB.

(3) Message 2 (Msg 2)

The way how to receive the random access response information is similar to the contention-based random access procedure described above. That is, the UE transmits the random access preamble and then, attempts to receive the random access response of its own within the random access response window instructed by through system information or handover command by the eNB. Through this, it is available to receive UL grant, temporary C-RNTI and TAC and so on.

In the non-contention-based random access procedure, the random access procedure may be terminated judging that the random access procedure is normally completed by receiving the random access response information.

Device-to-Device (D2D) Communication

A Device-to-Device (D2D) communication technology means a scheme in which terminals which are geographically proximate to each other directly communicate with each other without using an infrastructure such as the base station. As the D2D communication technology, technologies primarily using an unlicensed frequency band have been developed, such as Wi-Fi Direct and Bluetooth. However, development and standardization of the D2D communication technology using a licensed frequency band are in progress for the purpose of improving frequency use efficiency of a cellular system.

In general, the D2D communication as a term which denotes communication between things or the M2M communication is limitedly used, but the D2D communication in the present invention may include all of communication among various types of devices having a communication function, such as a smart phone or a personal computer in addition to a simple device having the communication function.

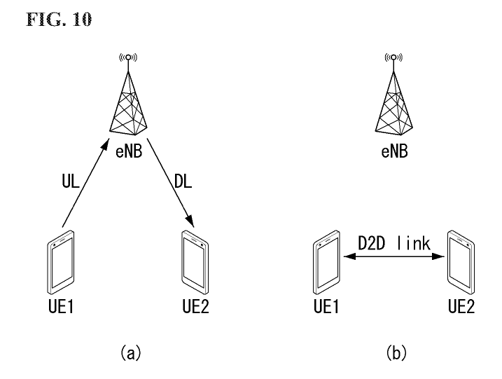

FIG. 10 is a diagram for conceptually describing D2D communication in the wireless communication system to which the present invention can be applied.

FIG. 10(a) illustrates a base station based communication scheme in the related art and terminal 1 (UE 1) may transmit data to the base station on the uplink and the base station may transmit data to terminal 2 (UE 2) on the downlink. The communication scheme may be referred to as an indirect communication scheme through the base station. In the indirect communication scheme, a Un link (as a link between the base stations or a link between the base station and a repeater, may be referred to as a backhaul link) which is a link defined in a wireless communication system in the related art and/or a Un link (as a link between the base station and the terminal or a link between the repeater and the terminal, may be referred to as an access link) may be associated.

FIG. 10(b) as one example of the D2D communication illustrates a UE-to-UE communication scheme and UE-to-UE data exchange may be performed without using the base station. The communication scheme may be referred to as a direct communication scheme between the devices. The D2D direct communication scheme has advantages including a decrease in latency, use of less radio resources, and the like as compared with the indirect communication scheme through the base station.

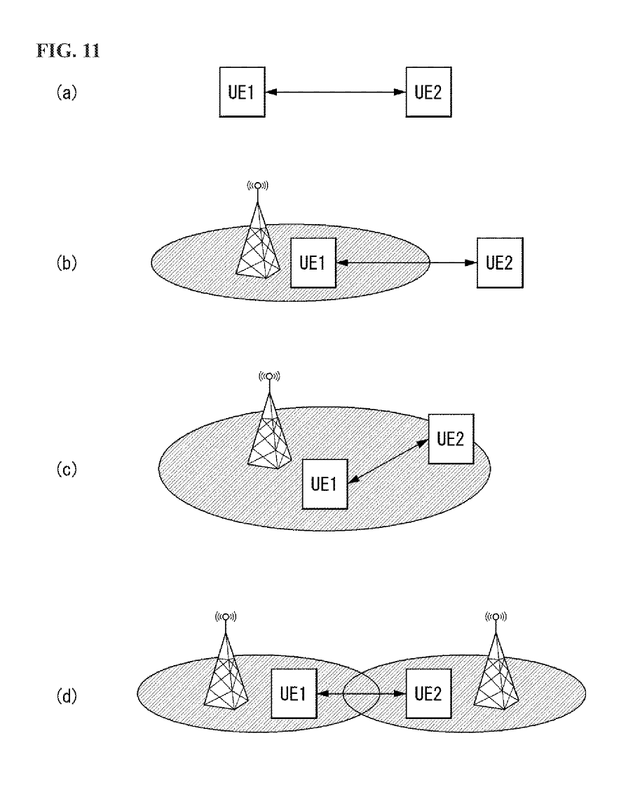

FIG. 11 illustrates one example of various scenarios of D2D communication to which a method proposed by the present specification can be applied.

A scenario of the D2D communication may be largely divided into (1) an Out-of-coverage network, (2) a partial-coverage network, and (3) an in-coverage network according to whether UE 1 and UE 2 are positioned in coverage/out of coverage.

The case of the in-coverage network may be divided into an in-coverage-single-cell and an in-coverage-multi-cell according to the number of cells corresponding to the coverage of the base station.

FIG. 11(a) illustrates one example of an Out-of-coverage network scenario of the D2D communication.

An out-of-coverage network scenario represents D2D communication between D2D terminals without control of the base station.

In FIG. 11(a), it may be illustrated that only UE 1 and UE 2 are present and UE 1 and UE 2 perform direct communication.

FIG. 11(b) illustrates one example of a partial-coverage network scenario of the D2D communication.

The partial-coverage network scenario represents performing the D2D communication between the D2D terminal positioned in the network coverage and the D2D terminal positioned out of the network coverage.

In FIG. 11(b), it may be illustrated that UE 1 positioned in the network coverage and UE 2 positioned out of the network coverage communicate with each other.

FIG. 11(c) illustrates one example of an in-coverage-single-cell scenario and FIG. 11(d) illustrates one example of an in-coverage-multi-cell scenario.

The in-coverage network scenario represents that the D2D terminals perform the D2D communication through the control of the base station in the network coverage.

In FIG. 11(c), UE 1 and UE 2 are positioned within the same network coverage (alternatively, cell) and perform the D2D communication under the control of the base station.

In FIG. 11(d), UE 1 and UE 2 are positioned in the network coverage, but positioned in different network coverage. In addition, UE 1 and UE 2 perform the D2D communication under the control of the base station managing each network coverage.

Hereinafter, the D2D communication will be described in more detail.

The D2D communication may operate in the scenario illustrated in FIG. 11, but in general, the D2D communication may operate in the coverage and out of the coverage. A link used for the D2D communication (UE-to-UE direct communication) may be referred to as D2D link, direct link, or sidelink, but hereinafter, the link used for the D2D communication will be collectively called and described as the sidelink for easy description.

Sidelink transmission may operate in an uplink spectrum in the case of FDD and operate in an uplink (alternatively, downlink) subframe in the case of TDD. Time division multiplexing (TDM) may be used for multiplexing the sidelink transmission and uplink transmission.

The sidelink transmission and the uplink transmissions do not simultaneously occur. The sidelink subframe partially or totally overlapped with the uplink subframe or UpPTS used for the uplink transmission, the sidelink transmission does not occur. Further, sidelink transmission and reception do not also simultaneously occur.

In the case of a structure of a physical resource used for the sidelink transmission, a structure of an uplink physical resource may be similarly used. However, a last symbol of the sidelink subframe is constituted by a guard period not to be used for the sidelink transmission.

The sidelink subframe may be configured by an extended CP or a normal CP.

The D2D communication may be largely divided into discovery, direct communication, and synchronization.

1) Discovery

The D2D discovery may be applied in the network coverage (including Inter-cell and Intra-cell). In inter-cell discovery, both synchronous and asynchronous cell deployments may be considered. The D2D discovery may be used for various commercial purposes including advertisement, coupon issue, friend finding, and the like for a terminal within a proximate area.

When UE 1 plays a role of transmitting a discovery message, UE 1 transmits the discovery message and UE 2 receives the discovery message. Transmission and reception roles of UE 1 and UE 2 may be exchanged with each other. The discovery message transmitted from UE 1 may be received by one or more UE(s) such as UE 2.

The discovery message may include a single MAC PDU and herein, the single MAC PDU may include a UE identifier (ID) and an application ID.

As a channel for transmitting the discovery message, a physical sidelink discovery channel (PDSCH) may be defined. As a structure of the PDSCH, a PUSCH structure may be reused.

As a resource allocation method for the D2D discovery, two types (Type 1 and Type 2) may be used.

In the case of Type 1, the base station may allocate a resource for transmitting the discovery message by a non-UE specific scheme.

In detail, a radio resource pool for discovery transmission and reception constituted by a plurality of subframe sets and a plurality of resource block sets is allocated within a specific period (hereinafter, referred to as ‘discovery period’) and discovery transmission UE arbitrarily selects a specific resource in the radio resource pool and thereafter, transmits the discovery message.

The periodic discovery resource pool may be allocated for transmitting a discovery signal by a semi-static scheme. Configuration information of the discovery resource pool for the discovery transmission includes the discovery period, subframe set and resource block set information which may be used for transmitting the discovery signal within the discovery period, and the like. The configuration information of the discovery resource pool may be transmitted to the UE by high layer signaling. In the case of in-coverage UE, the discovery resource pool for the discovery transmission may be configured by the base station and notified to the UE by using RRC signaling (e.g., a system information block (SIB)).

The discovery resource pool allocated for the discovery within one discovery period as a time-frequency resource block having the same size may be multiplexed by TDM and/or FDM and the time-frequency resource block having the same size may be referred to as ‘discovery resource’. The discovery resource may be divided by the unit of one subframe and include two physical resource blocks (PRBs) per slot in each subframe. One discovery resource may be used for transmitting a discovery MAC PDU by one UE.

Further, the UE may repeatedly transmit the discovery signal within the discovery period for transmitting one transport block. The MAC PDU transmitted by one UE may be repeatedly (e.g., repeatedly four times) contiguously or non-contiguously within the discovery period (that is, the radio resource pool). The number of transmission times of the discovery signal for one transport block may be transmitted to the UE by the high layer signaling.

The UE may arbitrarily select a first discovery resource in a discovery resource set which may be used for repeated transmission of the MAC PDU and other discovery resources may be determined in association with the first discovery resource. For example, a predetermined pattern may be previously set and the next discovery resource may be determined according to the previously set pattern according to a position of the discovery resource which the UE first selects. Or, the UE may arbitrarily select each discovery resource in the discovery resource set which may be used for the repeated transmission of the MAC PDU.

In Type 2, the resource for transmitting the discover message is UE-specifically allocated. Type 2 is subdivided into Type 2A (Type-2A) and Type 2B (Type-2B). Type 2A is a scheme in which the base station allocates the resource every transmission instance of the discovery message within the discovery period and Type 2B is a scheme in which the base station allocates the resource by a semi-persistent scheme.

In the case of Type 2B, RRC_CONNECTED UE requests allocation of the resource for transmitting the D2D discovery message to the base station through the RRC signaling. In addition, the base station may allocate the resource through the RRC signaling. When the UE is transitioned to the RRC_IDLE state or when the base station withdraws the resource allocation through the RRC signaling, the UE release a transmission resource which is allocated most recently. As described above, in the case of Type 2B, the radio resource may be allocated by the RRC signaling and activation/deactivation of the radio resource allocated by the PDCCH may be determined.

The radio resource pool for receiving the discovery message may be configured by the base station and notified to the UE by using the RRC signaling (e.g., the system information block (SIB)).

The UE that receives the discovery message monitors both the discovery resource pools of Type 1 and Type 2 in order to receive the discovery message.

2) Direct Communication

An application area of the D2D direct communication includes even a network coverage edge-of-coverage area as well as network in-coverage and out-of-coverage areas. The D2D direct communication may be used for a purpose such as public safety, or the like.

When UE 1 plays a role of transmitting direct communication data, UE 1 transmits the direct communication data and UE 2 receives the direct communication data. Transmission and reception roles of UE 1 and UE 2 may be exchanged with each other. The direct communication transmission from UE 1 may be received by one or more UE(s) such as UE 2.

The D2D discovery and the D2D communication may not be associated with each other but independently defined. That is, in groupcast and broadcast direct communication, the D2D discovery is not required. As such, when the D2D discovery and the D2D direct communication are independently defined, the UEs need not recognize adjacent UE. In other words, in the case of the groupcast and broadcast direct communication, all receiving UEs in a group are not required to be proximate to each other.

As a channel for transmitting the D2D direct communication data, a physical sidelink shared channel (PSSCH) may be defined. Further, as a channel for transmitting control information (e.g., scheduling assignment (SA), a transmission format, and the like for transmitting the direct communication data) for the D2D direct communication, a physical sidelink control channel (PSCCH) may be defined. As the structures of the PSSCH and the PSCCH, the PUSCH structure may be reused.

As a resource allocation method for the D2D direct communication, two modes (mode 1 and mode 2) may be used.

Mode 1 represents a scheme in which the base station schedules a resource used for transmitting data or control information for the D2D direct communication to the UE. In the in-coverage, mode 1 is applied.

The base station configures the resource pool required for the D2D direct communication. Herein, the resource pool required for the D2D communication may be divided into a control information pool and a D2D data pool. When the base station schedules control information and D2D data transmission resources within a pool configured for transmitting D2D UE by using the PDCCH or ePDCCH, the transmitting D2D UE transmits control information and D2D data by using an allocated resource.

The transmitting UE requests a transmission resource to the base station and the base station schedules resources for transmitting the control information and the D2D direct communication data. That is, in the case of mode 1, the transmitting UE needs to be in the RRC_CONNECTED state in order to perform the D2D direct communication. The transmitting UE transmits the scheduling request to the base station and thereafter, the buffer status report (BSR) procedure is performed so that the base station determines the quantity of resources requested by the transmitting UE.

When receiving UEs monitor the control information pool and decodes control information associated therewith, the receiving UEs may selectively decode D2D data transmission associated with the corresponding control information. The receiving UE may not decode the D2D data pool according to a control information decoding result.

Mode 2 represents a scheme in which the UE arbitrarily selects a specific resource in the resource pool in order to transmit data or control information for the D2D direct communication. In the out-of-coverage and/or edge-of-coverage, mode 2 is applied.

In mode 2, the resource pool for transmitting the control information and/or the resource pool for transmitting the D2D direct communication data may be pre-configured or semi-statically configured. The UE receives the configured resource pool (a time and a frequency) and selects the resource for the D2D communication transmission. That is, the UE may select the resource for transmitting the control information in the control information resource pool in order to transmit the control information. Further, the UE may select the resource in the data resource pool in order to transmit the D2D direct communication data.

In D2D broadcast communication, the control information is transmitted by a broadcasting UE. The control information indicates explicitly and/or implicitly a position of a resource for data reception in association with the physical channel (that is, PSSCH) transporting the D2D direct communication data.

3) Synchronization

A D2D synchronization signal/sequence (D2DSS) may be used for the UE to acquire time-frequency synchronization. In particular, since the control of the base station is impossible out of the network coverage, a new signal and a new procedure for establishing UE-to-UE synchronization may be defined. The D2D synchronization signal/sequence (D2DSS) may be referred to as a sidelink synchronization signal.

A UE that periodically transmits the D2D synchronization signal/sequence (D2DSS) may be referred to as a D2D synchronization source or a sidelink synchronization source. When the D2D synchronization source is the base station, a structure of the D2D synchronization signal/sequence (D2DSS) may be the same as the PSS/SSS. When the D2D synchronization source is not the base station (for example, the UE or a global navigation satellite system (GNSS)), the structure of the D2D synchronization signal/sequence (D2DSS) may be newly defined.

The D2D synchronization signal/sequence (D2DSS) is periodically transmitted with a period which is not smaller than 40 ms. Each UE may have multiple physical-layer D2D synchronization identities. The physical-layer D2D synchronization identity may be referred to as a physical-layer sidelink synchronization identity or just referred to as a D2D synchronization identity.

The D2D synchronization signal/sequence (D2DSS) includes a D2D primary synchronization signal/sequence and a D2D secondary synchronization signal/sequence. The D2D primary synchronization signal/sequence and the D2D secondary synchronization signal/sequence may be referred to as a primary sidelink synchronization signal (PSSS) and a secondary sidelink synchronization signal (SSSS), respectively.

Before transmitting the D2D synchronization signal/sequence (D2DSS), the UE may first search the D2D synchronization source. In addition, when the D2D synchronization source is searched, the UE may acquire the time-frequency synchronization through the D2D synchronization signal/sequence received from the searched D2D synchronization source. In addition, the corresponding UE may transmit the D2D synchronization signal/sequence.

Further, a channel may be required, which is used for purpose of transferring system information and synchronization-related information used for the UE-to-UE communication together with synchronization and the channel for the purpose may be defined. The channel may be referred to as a physical D2D synchronization channel (PD2DSCH) or a physical sidelink broadcast channel (PSBCH).

Hereinafter, direct communication between two devices in the D2D communication is described as an example for clarity, but the scope of the present invention is not limited thereto and the same principle described in the present invention may be applied even to D2D communication among two or more plural devices.

D2D Discovery

Hereinafter, in the present description, a signal (alternatively, message) which the UEs periodically transmit for the D2D discovery may be referred to as the discovery message, the discovery signal, a beacon, and the like. Hereinafter, the discovery message, the discovery signal, the beacon, and the like are collectively called the discovery message.

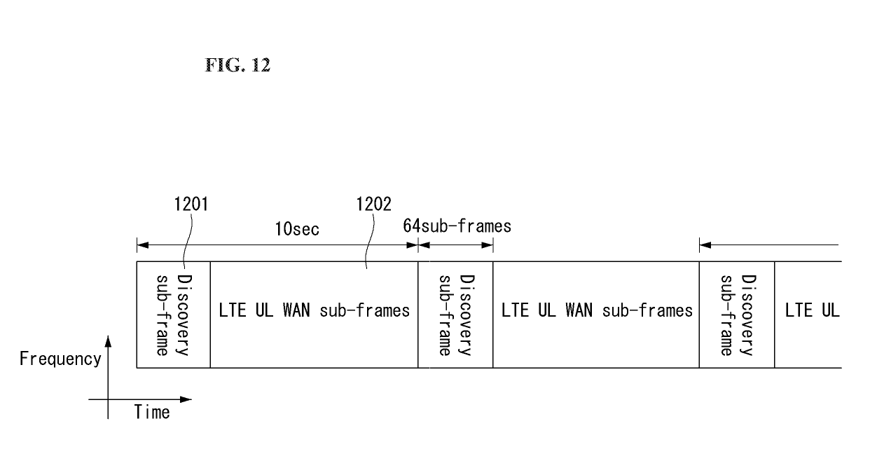

In distributed discovery, as a resource used for the UE to transmit and receive the discovery message, a dedicated resource may be periodically allocated apart from a cellular resource. The dedicated resource will be described below with reference to FIG. 12.

FIG. 12 is a diagram for describing a distributed discovery resource allocating method in the wireless communication system to which the present invention can be applied.

Referring to FIG. 12, in a distributed discovery scheme, a discovery subframe (that is, a ‘discovery resource pool’) 1201 for discovery among all cellular uplink frequency-time resources is fixedly (alternatively, dedicatedly) allocated and the residual area is constituted by an LTE uplink wide area network (WAN) subframe area 1202 in the related art. The discovery resource pool may be constituted by one or more subframes.

The discovery resource pool may be periodically allocated at a predetermined time interval (that is, a ‘discovery period’). Further, the discovery resource pool may be repeatedly configured within one discovery period.

FIG. 12 illustrates an example in which the discovery resource pool is allocated with a discovery period of 10 sec and 64 consecutive subframes are allocated to the respective discovery resource pools. However, the size of the time/frequency resource of the discovery period and the discovery resource pool corresponds to one example and the present invention is not limited thereto.

The UE autonomously selects the resource (that is, the ‘discovery resource’) for transmitting the discovery message thereof in the dedicatedly allocated discovery pool and transmits the discovery message through the selected resource.

D2D Direct Communication

The D2D control information may be referred to as sidelink control information (SCI) or scheduling assignment (SA). As described above, the D2D control information may be transmitted on the PSCCH and the D2D data may be transmitted on the PSSCH. Hereinafter, the D2D control information will be referred to as SA.

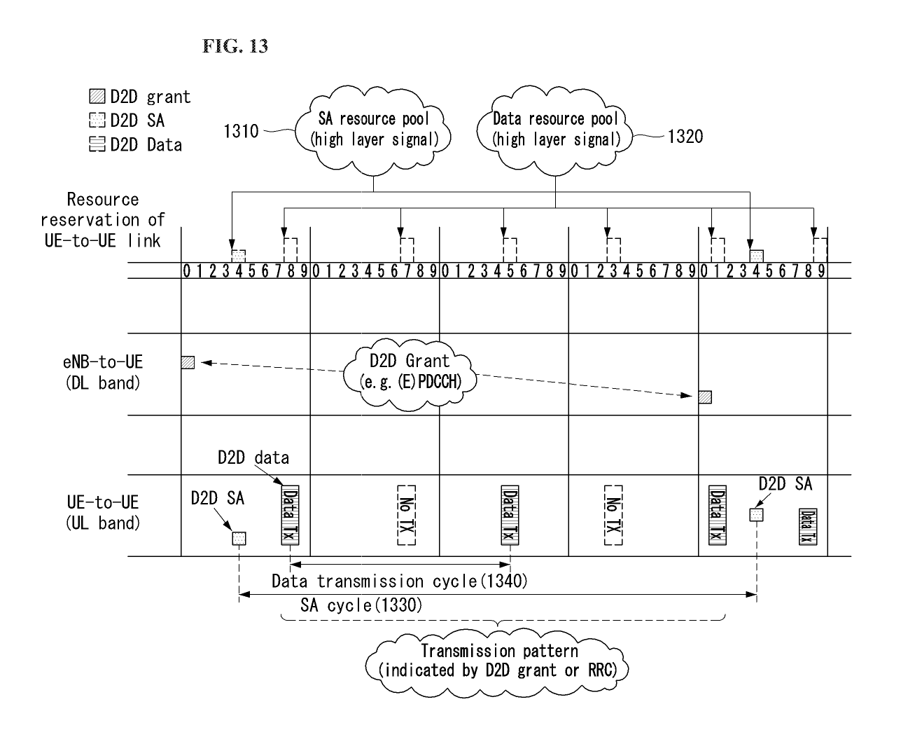

FIG. 13 is a diagram for describing a method for transmitting/receiving signaling for D2D direct communication in the wireless communication system to which the present invention can be applied.

FIG. 13 illustrates a method that performs the D2D communication by transmitting/receiving a D2D operating procedure in a D2D operating procedure (D2D communication Mode 1) by the control of the base station and information associated therewith.

As illustrated in FIG. 13, a scheduling assignment (SA) resource pool 1310 and/or a data resource pool 1320 associated with the D2D communication may be pre-configured and the pre-configured resource pool may be transmitted from the base station to the D2D UEs through the high layer signaling.

The high layer signaling may be the RRC signaling.

An expression of ‘A and/or B’ used in the specification may be interpreted as a concept meaning at least one of A and B (indicating A, B, or A & B).

The SA resource pool and/or data resource pool means a resource reserved for the D2D (UE-to-UE) link or the D2D communication.

The UE-to-UE link may be expressed as sidelink.

In detail, the SA resource pool means a resource area to transmit the SA and the data resource pool means a resource area to transmit the D2D data.

The SA may be transmitted according to an SA period 1330 and the D2D data may be transmitted according to a data transmission period 1340.

The SA period and/or the data transmission period may be transmitted from the base station to the D2D UE through a D2D grant.

Alternatively, the SA period may be transmitted through the D2D grant and the data transmission period may be transmitted through the SA.

Herein, the D2D grant represents downlink control information (DCI) required for transmitting the SA and the D2D data transmitted to the D2D UE by the base station.

The D2D grant may be expressed as DCI format 5 and transmitted through the physical layer channels including the PDCCH, the EPDCCH, and the like or an MAC layer channel.

Further, the D2D grant may include information associated with SA transmission and information associated with data transmission.

The SA may include a resource allocation (RA), an MCS, a new data indicator (NDI), a redundancy version (RV), and the like as an example.

As described above, the SA resource pool for the SA transmission may be transmitted through the RRC signaling.

Further, the SA may be transmitted through the Physical Sidelink Control Channel (PSCCH) and the D2D data may be transmitted through the Physical Sidelink Shared Channel (PSSCH).

The D2D transmitting UE may receive SA information, in particular, resource allocation (RA) information (hereinafter, referred to as ‘SA RA’ information) in which the SA may be transmitted, from the base station through the D2D grant.

In this case, the D2D transmitting UE may transmit the SA RA information received from the base station to the D2D receiving UE as it is or generate new SA RA information by referring to the received SA RA information and thereafter, transmit the newly generated SA RA information to the D2D receiving UE.

Herein, when the D2D transmitting UE newly generates the SA RA, the D2D transmitting UE needs to perform resource allocation of the SA only within the resource pool indicated by a D2D grant RA.

That is, the D2D transmitting UE may transmit the SA by selecting only a partial resource area (SA RA) in the resource area (D2D grant RA) which eNB allows to be used.

Alternatively, contrary to this, the D2D transmitting UE may use the D2D grant RA allocated by the eNB as it is.

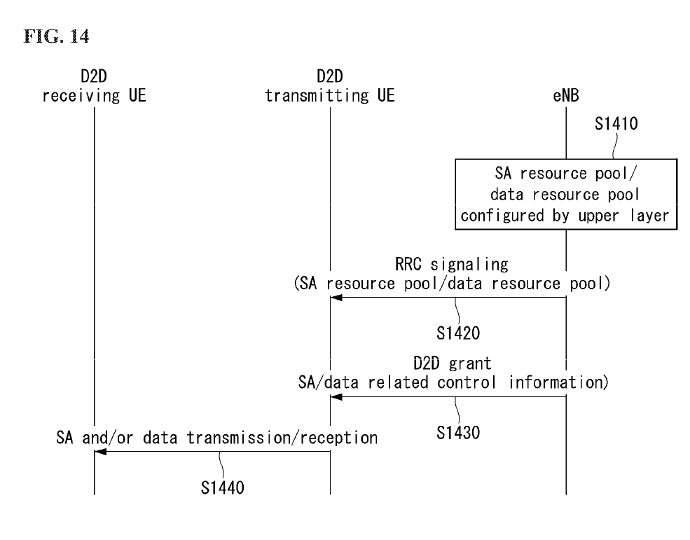

FIG. 14 is a diagram for describing a method for transmitting downlink control information for D2D direct communication in the wireless communication system to which the present invention can be applied.

First, the SA resource pool and/or D2D data resource pool associated with the D2D communication are/is configured by a high layer (S1410).

Thereafter, the base station transmits the SA resource pool and/or D2D data resource pool to the D2D UE through the high layer signaling (S1420).

Thereafter, the base station transmits control information associated with the SA and/or control information associated with the D2D data to the D2D transmitting UE through the D2D grant separately or together (S1430). The control information includes scheduling information of the SA and/or D2D data in the SA resource pool and/or D2D data resource pool. The control information may include the RA, the MCS, the NDI, the RV, and the like as one example.

Thereafter, the D2D transmitting UE transmits the SA and/or D2D data to the D2D receiving UE based on the information received in step S1430 (S1440).

The SA transmission and the D2D data transmission may be simultaneously performed or the D2D data may be transmitted after the SA is transmitted.

Meanwhile, although not illustrated in FIG. 14, the D2D transmitting UE requests a transmission resource (that is, a PSSCH resource) for the D2D data to the base station and the base station may schedule resources for transmitting the SA and the D2D data. To this end, the buffer status report (BSR) procedure may be performed so that the D2D transmitting UE transmits the scheduling request (SR) to the base station and thereafter, the base station determines the quantity of resources requested by the D2D transmitting UE.

Herein, Since the SR is the SR for requesting allocation of not the PUSCH resource but the PSSCH resource, the SR may be distinguished from the SR for requesting the PUSCH resource. To this end, in order to distinguish the SR for the PSSCH from the SR for the PUSCH, a PUCCH resource index (that is, the PRB in which the SR is transmitted), a cyclic shift (CS) applied to the basic sequence (e.g., ZC sequence) for frequency domain spread of the SR, and an orthogonal code (OC) for time domain spread of the SR may be differently configured.

When the D2D Rx UEs monitor the control information pool and decodes control information associated therewith, the D2D Rx UEs may selectively decode D2D data transmission associated with the corresponding control information.

The D2D grant serves to allocate the resources which the D2D Tx UE requires for transmitting the SA and the data and transfer the control information including the MCS, and the like, that is, the scheduling information, as described above.

Further, since the SCI is used for scheduling the PSSCH from the viewpoints of the D2D Tx UE and the D2D Rx UE, a DCI format for the D2D grant proposed in the present invention may be used for scheduling the PSSCH and include field information of the SCI.

The DCI format for the D2D grant (alternatively, the sidelink grant) includes both the scheduling for the SA and the data as described above, but a resource allocation assignment/allocation (RA) field (alternatively, information) for the SA and an RA field (alternatively, information) for the data may be distinguished from each other.

For example, the DCI format for the D2D grant may be constituted by a frequency hopping flag (FH) field, a resource allocation (RA) field for the D2D SA, a first RA field for the D2D data, a second RA field for the D2D data, a TPC field, and a zero padding (ZP) bit(s) (a case in which the ZP bit(s) is(are) present).

The FH field indicates whether frequency hopping is applied at the time of transmitting the SA and the data. Since the FH field may be commonly applied to the SA transmission and the data transmission, the FH field may be constituted by one field.

For example, when an FH field value is ‘1’, the D2D Tx UE performs frequency hopping transmission at the time of transmitting the SA and the data and when the FH field value is ‘0’, the D2D Tx UE does not perform the frequency hopping transmission at the time of transmitting the SA and the data.

The SA RA field (alternatively, a PSCCH RA field, a resource field for the PSCCH) indicates resource information for the SA transmission. That is, the SA RA field indicates scheduling information (that is, resource information) for PSCCH transmission. Therefore, the D2D Tx UE transmits the SA (that is, the PSCCH) in a resource indicated by the SA RA field.

Herein, the SA RA field may also include information (alternatively, an index) for deriving a time for the SA transmission and/or a position of the frequency resource area.

For example, the SA RA field may announce a start position (that is, the index) of the resource for the SA transmission. In other words, the SA RA field may indicate a start index of a subframe and/or a resource block in which the SA is transmitted.

Further, the D2D Tx UE may derive a time resource (e.g., a subframe index) and/or a frequency resource (e.g., a resource block index) for the SA transmission by using a predetermined function (equation) based on the information included in the SA RA field.

The resource allocation information for the D2D data transmission may be constituted by a D2D data first RA field (alternatively, a first PSSCH RA field, a resource block allocation and hopping resource allocation field), a D2D data second RA field (alternatively, a second PSSCH RA field, a time resource pattern field).

The D2D data first RA field indicates the resource information (e.g., the resource block) for the D2D data transmission in the frequency domain. That is, the D2D data first RA field indicates the scheduling information in the frequency domain for the PSSCH transmission. Therefore, the D2D Tx UE transmits the D2D data (that is, the PSSCH) in a frequency resource indicated by the D2D data first RA field.

For example, the D2D data first RA field may indicate a start position (that is, a start resource block index) of the resource block for the D2D data transmission and the length of the allocated resource block by using a resource indication value (RIV) like a UL RA scheme.

Further, the D2D data first RA field may separately and announce the start position (that is, the start resource block index) and an end position (that is, a last resource block index) of the resource block for the D2D data transmission as separate fields (alternatively, information). In this case, an additional bit (e.g., 1 bit) may be further required.

The D2D data second RA field indicates resource information (e.g., the subframe) used for the D2D data transmission in the time domain. That is, the D2D data second RA field indicates the scheduling information in the time domain for the PSSCH transmission. Therefore, the D2D Tx UE transmits the D2D data (that is, the PSSCH) in a time resource indicated by the D2D data first RA

### FIELD

For example, the D2D data second RA field may indicate a subframe pattern (that is, a time resource pattern) to be used for the D2D data transmission. That is, the D2D data second RA field may include information indicating the time resource pattern used for the PSCCH transmission.

Herein, the D2D data second RA field may indicate any one pattern of a plurality of predetermined time resource patterns. For example, n subframe patterns (expressed by a bitmap) may be pre-defined like SF pattern #0(10001010), SF pattern #1(00111001), . . . , SF pattern #n(10011001) and the D2D data second RA field may indicate any one subframe pattern of n defined subframe patterns. Herein, a value of ‘1’ of the bitmap may mean that the D2D data is transmitted in a corresponding subframe and a value of ‘0’ may mean that the D2D data is not transmitted in the corresponding subframe. Further, the values of the bitmap may have meanings contrary thereto.

A TPC field indicates transmission power for the SA and data transmission in the D2D Tx UE. That is, the TPC field indicates transmission power information of the PSCCH and the PSSCH.

The TPC field may be constituted by one field. As such, when the TPC field is constituted by one field, the TPC field value is commonly applied to the transmission power for the SA transmission and the transmission power for the data transmission.

The ZP may be filled with the control information, not used, or not present as necessary. That is, when the ZP is not required, the ZP may be omitted.

Each field order and a bit count of each bit of the DCI format exemplified as above are just one example for easy description and may be modified.

Meanwhile, as compared with DCI format 0 given above, the DCI format for the D2D grant exemplified as above may not include the MCS field.

When the eNB announces the MCS value to the D2D Tx UE, the MCS field needs to be present in the DCI format for the D2D grant. However, the D2D Tx UE may autonomously determine the MCS value or the MCS value may be transferred through the higher layer signaling (e.g., the RRC signaling) or determined as a pre-fixed value. Accordingly, the D2D grant does not include the MCS field.

Further, the DCI format for the D2D grant exemplified as above may not include even the NDI field and the RV field. Similarly to the above, the D2D Tx UE may autonomously determine the NDI and RV values or the NDI and RV values may be transferred through the higher layer signaling (e.g., the RRC signaling) or determined as pre-fixed values.

Public Safety (PS) Service Using D2D Technology

The present invention proposes a method for transmitting to a specific server system “information such as D2D IDs, and like collected from a UE, a black box, a vehicle, and the like supporting a D2D function, which are positioned nearby” based on the person to an accident “for past predetermined time around an accident occurrence time” when particular situations including such as an emergency situation, and the like occur. As such, the present invention relates to a public interest pursuit service which assists solving the emergency situations by providing an opportunity to request and secure detailed information on the then accident situation, which is recorded in the D2D UE, the black box, and the vehicle positioned to be proximate to the emergency situation by finding an actual device ID or a user through deciphering a D2D ID which is proximate to an emergency situation occurrence point and a technical method for implementing the same.

More accurate and reliable information than a statement of a witness which witnesses a site of the emergency situation may be secured through a process of generating and collecting the D2D signal and finding the corresponding person (UE) and a ground to definitely establish the rights and wrongs which may occur due to lack of evidence may be secured.

As another implementation example of a proposal method, the proposal method may be implemented even by a process in which the person to the accident, the UE, and the vehicle directly transmit a request signal to receive an accident related record in an adjacent witness, the UE, the vehicle, the black box. Rapid signal transmission is required so as to prevent persons or vehicles positioned at an accident site from deviating from D2D coverage. In this case, a method that automatically transmits the signal by recognizing a vehicle situation by interlocking with a collision prevention system of the vehicle, and the like may be together used.

Herein, even though detailed description of the method for transmitting the D2D discovery signal (i.e., PSDCH) or the D2D direct communication control information (i.e., PSCCH)/data (i.e., PSSCH) is not mentioned, the aforementioned method according to FIGS. 10 to 14 may be similarly applied.

Hereinafter, an adjacent UE positioned within predetermined coverage (e.g., a maximum effective distance capable of securing the D2D ID) of a location where the emergency situation occurs may be appreciated as the D2D UE group.

FIG. 15 is a diagram illustrating a user interface at the time of implementing a method for collecting a D2D ID proximity-based notification according to an embodiment of the present invention.

FIG. 15(a) illustrates the user interface (UI) displayed on the screen of UE (UE A) of the person directly concerned, which is placed in the emergency situation just after the emergency situation occurs. The UI of FIG. 15(a) may be displayed on the screen of the UE when an associated application is driven.

In FIG. 15(a), A 1501 represents a position (that is, the position of UE A) of the UE of the person directly concerned or a position where the emergency situation occurs and a dotted line (coverage 1503) is a maximum effective distance (e.g., 1 km) capable of securing the D2D ID of the UE which broadcasts the discovery signal nearby. Further, the position of an adjacent UE 1502 transmitting the discovery signal is displayed within the coverage 1503 capable of securing the D2D ID.

A technique capable of verifying its own position includes a method for using a GPS. In addition, a LTE/LTE-A positioning technique may be used. That is, a technique of verifying positions of UEs by receiving a positioning reference signal (PRS) transmitted by a neighboring base station to analyze a difference in arrival time of the received signal may be used.

However, the technique has a limit in that the person directly concerned just verifies the position thereof and may not verify the positions of other persons. As one method for overcoming the limit, a D2D technique may be used. For example, the D2D UE transmits the discovery signal to adjacent base stations based on a transmission time acquired by performing individual synchronization and the D2D UE may find an absolute position thereof by analyzing a difference in arrival time of signals transmitted according to different base station timings and similarly, determine even the absolute positions of other UEs. In this case, it is assumed that the D2D UE has known positional information of the base station in advance.

The position of UE A or an adjacent UE (including UE B) obtained by such a method is displayed on the screen of UE A.

UE A obtains the D2D IDs of the adjacent UEs that transmit the discovery signal and transmits the obtained D2D IDs to the server (e.g., the server of a police (a public institution or a server management company to which the public institution entrusts a role), and the like). Herein, the server may be implemented as the base station or a network node (e.g., MME or an M2M server).

As described above, the D2D ID is transferred while being included in the discovery message. In this case, UE A may transmit to the server information associated with the emergency situation, such as an emergency situation type, an emergency situation occurrence time, an emergency situation occurrence position, or an emergency situation strength/intensity together with the obtained D2D ID.

As such, in respect to the information collected by UE A, a case where the information collected by UE A is automatically transmitted when the emergency situation occurs and a case where the collected information is manually directly transmitted may be considered.

The reason for using the automatic transmission is that occurs because as the person suffers from a sudden emergency situation, the person may not directly request an SOS, that is, a case where the person may not operate the terminal, in this case, an SOS signal needs to be automatically transmitted (that is, the D2D ID needs to be transmitted to the server) by sensing body states (a heartbeat, a blood flow, and the like) of the person directly concerned with the emergency situation or impact, noise, and a surrounding situation at the time when the emergency situation. For example, when a difference from normal times is sensed by sensors (e.g., sensors capable of sensing the heartbeat, a pulse, a breath, a blood pressure, and the like, sensors capable of sensing an acceleration, the impact, and the like, sensors capable of sensing a surrounding temperature, noise, and the like) mounted on UE A by a threshold or more is sensed, it may be determined that the emergency situation occurs and the obtained D2D ID of the adjacent UE may be transmitted to the server. On the contrary, in the case where the person directly concerned manually transmits the SOS, when the user directly presses a transmission button, the obtained D2D IDs of the UEs around the emergency situation occurrence position are transmitted to the server.

Personal information of the user of the corresponding UE is found from the transmitted D2D IDs for the server to determine whether accident associated information may be provided by establishing a contact with the respective users. That is, a user (that is, UE) that belongs to a registration list 1505 of service joining users is found among the D2D IDs included in a D2D ID 1504 requested by UE A to determine whether the accident associated information may be provided.

FIG. 15(c) illustrates the U displayed on the screen of UE (UE B) (e.g., an emergency situation witness (a vehicle passenger, a witness of a surrounding street, and the like)) which is proximate to the location where the emergency situation occurs just after the emergency situation occurs. In FIG. 15(c), B 1506 represents the position of the user's own terminal and a position 1507 where the emergency situation occurs is together displayed.

That is, when the server transmits a query message for querying whether the emergency situation associated information may be provided to UE B included in the registration list 1505, a query message window of FIG. 15(c) may be displayed on the screen in UE B. Further, the server may transmit even the information including the emergency situation occurrence time, the emergency situation occurrence position, and the like to UE B together with the query message.

In spite of the D2D UE that is preset within the coverage of the UE which suffers from the emergency situation, responding to a request will follow a free will of a person which receives the request. By considering such a point, an access method may be considered, in which the user/UE which intends to use the corresponding service in advance agrees to has his/her intention to provide his/her accident witness/recording information when the accident occurs. In this case, proposed is that the D2D ID is collected by distinguishing UE that agrees to provide the information among the D2D UEs that are present in the coverage of the accident.

In order to implement the proposal, the D2D discovery signal which an information providing consenter UE transmits needs to include indication information notifying information providing agreement. A specific field on a discovery signal format is defined to be used for such a purpose.

As another implementation method, a method is also available, in which the server compares the D2D ID collected from UE A and the D2D ID of the information providing consent to not record but delete a D2D ID which is not consented. That is, the above registration list 1505 may mean the user/UE that agrees to providing the information.

When the information collected by the server is a lot, usage of a memory increases, and as a result, implementation cost increases. Therefore, it is preferable that the adjacent collected D2D ID and associated information are minimized and stored and temporarily kept. In such an aspect, it is preferable to secure only a useful D2D ID and seek an assistance requester by querying the information to the server.

Further, the indication information may indicate that even the user which agrees to provide the information may not provide the information due to a personal circumstances or temporarily and it should be determine whether the information is recorded and kept by collecting all of the conditions. In this case, a used indication bit may be similar to the aforementioned information providing agreement bit, but the indication bit may be implemented by defining a separate bit field. Further, the above information providing agreement indication bit and the information providing possible indication bit may not be just the bit field but may be transmitted in combination with specific information and transmitted through making with a specific bit.

In addition, in spite of the users which agree to providing the information in advance, UE A may transmit only D2D IDs of some user among the corresponding users to the server. In this case, for the purpose of facilitating system implementation, a method for selecting K D2D IDs is required when a transmission packet is configured so as to transmit only a maximum of K D2D IDs.

For example, a strength (e.g., RSRP, and the like) of a received signal, a signal to noise ratio (SNR), a signal to interference plus noise ratio (SINR), and the like become a reference, and as a result, only a D2D ID of UE in which a parameter is equal to or more than a threshold may be transmitted to the server.

One reason for determining the size of the packet is that in the case of emergent message transmission, it is preferable to transmit the packet having a size suitable for a limited resource previously allocated in order to rapidly transmit the message to a previously allocated resource area. In such an access method, a packet size suitable for the size of a reserved resource may be predetermined in advance. Consequently, the number of D2D IDs to which the packet may be transmitted cannot but be limitative.

In some accidents, in particular, in the case of an accident associated with public safety, the accident associated information providing may be forcibly executed so as to oblige the accident associated information providing. When such a service is activated, cost and time required for finding the witness is anticipated to be saved and the activation of the service will assist even keeping public order.

In this case, the person to the accident and the witness need not take the contact with each other. The collection of the D2D ID may be implemented even by a process in which the D2D ID is provided to the police and the police performs the subsequent accident treatment. In this case, since there is a possibility that fairness and reliability will be damage while the person directly concerned meets and provides the information, it may be more preferable that the public institution undertakes the task.

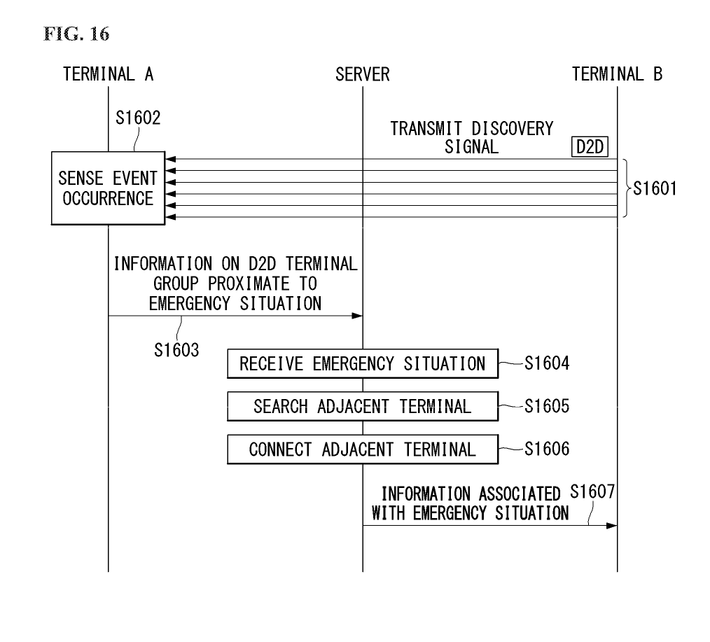

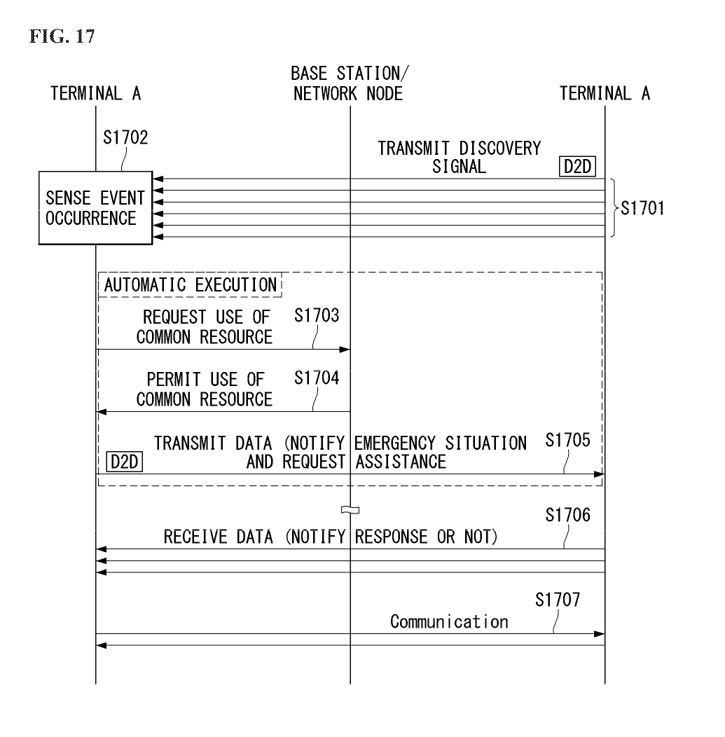

A signal flow associated with FIG. 15 may be divided into two cases and hereinafter, the two cases will be described with reference to FIGS. 16 and 17.

FIG. 16 is a diagram illustrating a D2D collecting method according to an embodiment of the present invention.

FIG. 16 illustrates an example of a case where a reporter uses the service, the reporter needs to manually make a report by personally executing the application which corresponds to a case where automatic sensing of the emergency situation or associated information may not be input. Further, such a case may be regarded as a case where when automatic transmission is turned off, manual transmission may be manually performed.

As mentioned above, it is assumed that UE (having an LTE D2D function such as the UE of the reporter receives an ID which meets a condition among LTE D2D discovery signals of adjacent (e.g., within a radius of 1 km) UEs and stores the received ID therein together with time information in real time at normal times (through option selection or by default on). A storage time or a memory allocation capacity is determined by a manufacturer or determined by a request or a regulation of an external agency such as a communication provider, or the like. Alternatively, an information retention time/period may be determined according to the type of the information.

Referring to FIG. 16, UE A (e.g., a reporter UE or an emergency situation concerned person terminal) receives the D2D discovery signal periodically or aperiodically transmitted from proximate UE B (e.g., a witness vehicle or UE) (S1601).

UE A senses (or detects) that an event occurs (S1602). Herein, the event represents a case where the emergency situation concerned person or an LTE D2D device user around the emergency situation executes an emergency reporting function embedded in the emergency situation concerned person UE when the emergency situation such as a traffic accident, or the like occurs. For example, execution of an application of performing a function to collect the D2D ID of the proximate UE/vehicle or input of a special button having an emergency call function, or the like may correspond to the occurrence of the event. Herein, when a counterpart UE (a predetermined UE) executes the emergency reporting function of UE A, the method is preferably implemented such a manner that the counterpart UE executes the corresponding emergency reporting function even though the counterpart UE does not know a password of UE A.

When the event occurrence is sensed like step S1602, D2D UE group information within a distance (e.g., within the radius of 1 km) corresponding to D2D coverage based on the position of UE A (alternatively, UE A user) is transmitted to the server (e.g., a police server) (S1603).

That is, a D2D UE group may be constituted by one or more adjacent UEs receiving the discovery signal of UE A.

Herein, the D2D UE group information may include the D2D ID of the UE or vehicle around the location (alternatively, the position of the concerned person UE) where the emergency situation occurs, the position (e.g., the position of the reporter) of UE A, the position of the emergency situation site, or emergency situation associated information. In this case, the D2D IDs mean D2D IDs of discovery signals received and stored before or after the emergency reporting function is executed. Further, the emergency situation associated information may include an emergency situation type, an emergency situation occurrence time, an emergency situation occurrence position, or an emergency situation strength/intensity.

Additionally, when there is no adjacent person, that is, when the D2D ID of the adjacent UE/vehicle may not be collected, UE A may notify to the server that there is no searched D2D ID. In addition, only the position of UE A (alternatively, the UE A user) and emergency situation associated information may be transmitted to the server. When other adjacent D2D UE/vehicle (that is, UE B) may determine a situation of obtaining the D2D ID of the accident concerned UE (that is, UE A) by using the information, the other adjacent D2D UE/vehicle may obtain adjacent UE information (that is, the D2D ID) collected by the adjacent D2D UE/vehicle (that is, UE B). In addition, the situation of the accident may be determined based on the obtained information and the accident may be solved.

The server receives the D2D UE group information from UE A to receive that the emergency situation occurs (S1604).

When the D2D UE group information including the D2D ID of the adjacent UE/vehicle is received while the server receives an emergency situation occurrence history, the server searches adjacent UE/vehicle (e.g., the witness) matching the D2D ID (S1605).

The server registers the searched adjacent UE/vehicle in an adjacent witness list, the server is connected with the user of the corresponding UE/vehicle through a call or message (S1606), and the server transmits the emergency situation associated information (S1607). As described above, the emergency situation associated information may include the emergency situation type, the emergency situation occurrence time, the emergency situation occurrence position, or the emergency situation strength/intensity.

For example, the information on the UE/vehicle around the emergency situation is collected as described above, and as a result, the police may indicate a policeman most adjacent to a region from which a report is received to patrol the corresponding region and in this case, the police may transmit the position of the reporter. The adjacent witness may accept or reject a traffic accident assistance request announced from the police. When the adjacent witness accepts or rejects the assistance request, whether the witness accepts or rejects the assistance request is automatically transmitted to the police server. When the witness accepts the assistance, the police treats the accident by receiving a statement of the witness by a general method (phone calling or the message). When the witness rejects the assistance, the witness is deleted from an adjacent witness list. However, when it is determined that the witness is important, the witness may be kept in the adjacent witness list apart from the response contents.

FIG. 17 is a diagram illustrating a D2D ID collecting method according to an embodiment of the present invention.

FIG. 17 illustrates an example in which when the occurrence of the emergency situation is sensed, the service is automatically executed. For example, in the case of a vehicle accident, a chip that performs the D2D communication function may be built in the vehicle or whether the accident occurs in the vehicle may be sensed through an accessory.

Referring to FIG. 17, UE A (e.g., a reporter UE or emergency situation concerted person UE) receives the D2D discovery signal periodically or aperiodically transmitted from proximate UE B (e.g., a witness vehicle (device) or UE) (S1701).

UE A senses (or detects) that an event occurs (S1702). Herein, the event means sensing the emergency situation by a sensor mounted on the D2D UE of the emergency situation occurrence concerned person when the emergency situation occurs.

As such, when the D2D UE detects the event, the emergency reporting function embedded in the device is automatically executed.

As one case of D2D resource allocation, a plurality of resource areas is allocated in a resource pool form from the base station in advance and when the D2D UE actually transmits data, the data is transmitted through a resource arbitrarily selected in a resource pool (resource allocation mode 2). However, when the number of UEs increases in the case where the UE personally arbitrarily selects a transmission resource, multiple UEs may simultaneously select and transmit the same resource, and as a result, a collision may occur in data transmission. Therefore, the resource allocation mode may cause a situation in which an emergency signal may not be transmitted when the emergency situation occurs.

As one method for improving the problem, resource allocation for D2D data is individually performed for each UE in real time. That is, when the D2D UE intends to transmit the D2D data, the D2D UE may request the resource allocation for transmitting the D2D data, acquire an approval for the request, and use an approved specific resource (resource allocation mode 1). However, due to a procedure in which a resource for transmitting the D2D data is allocated from the base station, the delay may occur and signaling overhead may increase. In particular, in order to the emergency signal, the emergency signal needs to be able to be transmitted anytime, but the delay may become a problem in transmitting the emergency signal.

Accordingly, a predetermined resource area is allocated as a resource area for transmitting the emergency signal and the limited resource area (an emergency resource area or a common resource) is used only in the case of the emergency situation. The emergency resource area may be set as a partial area in the resource pool for the D2D data (that is, the PSSCH) and set regardless of the resource pool for the D2D data (that is, the PSSCH).

Two following methods for using the emergency resource area may be considered.

First, the UE may arbitrarily select a specific resource of the emergency resource area without a resource allocation request (that is, SR) of the UE and transmit the D2D data (that is, the emergency signal) in the selected resource. Further, the UE may first perform an emergency resource request to the base station (alternatively, the network node) and receive an authentication of the base station (alternatively, the network node) and thereafter, transmit the emergency signal in the allocated resource.

In the case of the former, a situation may occur, in which multiple UEs indiscreetly transmit the emergency signal by a simple method or without a resource allocation request procedure at an accident occurrence location. In this case, a situation in which all emergency signals are blocked may be caused.

Accordingly, in spite of the emergency signal, it is preferable that a resource use request is rapidly transmitted to the base station (alternatively, the network node) and the emergency signal is transmitted through the resource allocated through an authentication like the latter method in using an emergency resource.

When the event occurrence is detected in step S1702 given above, UE A automatically requests verifying whether the emergency resource area (alternatively, the common resource) may be used to the base station (alternatively, the network node) (S1703).

In this case, information (indication) notifying that the transmitted signal is the emergency signal may be included in the emergency resource request. For example, in a PUCCH resource in which the emergency resource request may be transmitted so as to be distinguished from the SR in the related art, at least one of a PRB in which the SR is transmitted in the related art, a cyclic shift (CS) applied to the basic sequence (e.g., ZC sequence) for frequency domain spread of the SR in the related art, and an orthogonal code (OC) for time domain spread of the SR in the related art may be differently configured. The information may be regarded as a right to use an emergency signal dedicated resource area or control information included to acquire an authority to request resource allocation for using the emergency signal resource area.

The emergency resource area may be allocated by a prior resource allocation method (e.g., by system information (SIB or MIB) or high layer signaling). In this case, when there are a lot of pre-allocated resources and there is almost little emergency signal transmission, the corresponding resource may be wasted. Contrary to this, when the pre-allocated resource is short, a probability that the emergency signal will not be transmitted may increase. Accordingly, the size of the allocated resource area needs to be able to be controlled.

When the base station receives a use request of the emergency resource area (alternatively, the common resource) from UE A, the base station (alternatively, the network node) performs authentication of UE A (alternatively, the UE A user) that transmits the request with respect to the received emergency resource area use request and approves the use of the emergency resource area to UE A when the authentication is successful (S1704). In this case, in order to perform UE (alternatively, the user) authentication, the information (indication) notifying that the transmitted signal is the emergency signal may be used.

UE A that receives the approval of the emergency resource area use from the base station (alternatively, the network node) transmits the emergency signal to adjacent UE (that is, UE B) which belongs to the D2D UE group (S1705). That is, UE A transmits the emergency signal to UE B (that is, the adjacent UE) on the D2D discovery message (that is, the PSDCH) or the D2D data channel (that is, the PSSCH).

Here, the D2D UE group may be constituted by one or more adjacent UEs receiving the discovery signal of UE A.

Herein, as the emergency signal, the information (indication) notifying that the transmitted signal is the emergency signal may be used. For example, the indication may be transferred in a specific bit field of the D2D discovery message (that is, the PSDCH) or the D2D data channel (that is, the PSSCH) or the indication may be masked with a predetermined sequence.

UE (including UE B) around UE A may receive the emergency signal from UE A. Further, the UE (including UE B) around UE A may receive a notification of the emergency situation associated information from the base station (alternatively, the network node) through the emergency reporting function.

UE B that receives the emergency signal may accept or reject the assistance request for the received emergency signal and when UE B accepts or rejects the assistance request, UE B transmits a message indicating whether the assistance is accept to UE A (S1706).

When UE B accepts the assistance, UE A performs D2D direct communication through the secured emergency resource area when communication with UE B is available by a D2D method, but UE A performs communication with UE B by a general method (the phone call and the message) when the communication is unavailable by the D2D method (S1707).

For example, the information on the UE/vehicle around the accident is collected as described above, and as a result, the police may indicate a policeman most adjacent to a region from which a report is received to patrol the corresponding region and in this case, the position of the reporter may be transmitted to the policeman which performs patrolling. However, when the user of UE that receives the D2D emergency signal is the policeman, the policeman may immediately go to a site without a separate indication.

D2D Communication Method Based on a UE Condition

If a direct communication technology such as LTE D2D is applied to a mobile vehicle (e.g., a vehicle device) and a portable UE (e.g., a smartphone), a D2D operation between a vehicle and a UE, i.e., a direction communication, is possible. Namely, in the case of LTE D2D, for example, D2D discovery operation and D2D communication operation become possible. In other words, a D2D possible vehicle and smartphone existing nearby may be searched, and data may be transmitted and received between these devices.

Such a direct communication technology between a vehicle and a portable UE or between a plurality of vehicles may be utilized for various purposes such as a safety service between vehicles and a service for protecting a person. For example, when a pedestrian enters a roadway, a warning message may be shown on the pedestrian's UE so that the pedestrian may recognize a dangerous situation and at the same time, a warning message may be shown in the related vehicles so that the vehicles may stop or detour around the pedestrian.

Such an operation is possible because a D2D device (e.g., a vehicle device, a UE, etc.) existing nearby may be searched by utilizing a D2D discovery signal.

In the case of a direct short range communication (DSRC), which is the existing similar direct communication technology, the operation of searching for a neighbor UE is not possible, and thus the technology can support only the service of assisting the safety by performing a simple operation of broadcasting the message of the UE itself at a designated time.

Yet, if the LTE D2D is utilized, it is possible to recognize information on which type of UE approaches to what extent by first searching for a neighbor UE or UE. Such in-advance recognized information may be utilized for the purpose of providing a service in the form which is necessary to a specifically selected UE in the UE, i.e., a customized service. For example, if a D2D device mounted on a vehicle discovers a neighbor vehicle, the D2D device may transmit a message, which fits the vehicle or may be analyzed, and if the D2D device discovers a UE such as a smartphone, the D2D device transmits a message which may be recognized by the UE. This means that the D2D device can provide the technology of providing a service customized to the target UE.

The V2X (Vehicle to Everything) technology, which utilizes LTE D2D, includes communication between a vehicle and all objects such as V2V (Vehicle to Vehicle), V2I (Vehicle to Infrastructure), and V2P (Vehicle to Pedestrian).

Particularly, in the V2P service, the vehicle may accurately recognize the location of the UE, recognize a situation that the user is in danger, for example, a situation that the user is jaywalking, and send a warning message to the user.

Here, what is important is to accurately recognize the situation based on the accurate location. If the location is not accurate, it is not possible to recognize whether the user is on a sidewalk or a driveway and it is not possible to recognize the direction in which the user is moving. Therefore, the accuracy will be an important factor determining the usefulness of this service.

Assuming the case that such accuracy is guaranteed, respective appropriate operations should be performed for the following various cases. For example, it is assumed that there are passengers A and B riding on vehicle 1, passengers C and D riding together on moving vehicle 2 in a short distance, passengers E and F riding on vehicle 3 moving on a lane of the opposite side, and pedestrian P in a short distance.

For example, generally a service that vehicle 1 protects pedestrian P may be considered. In this service, it is important that vehicle 1 accurately recognizes person P as a pedestrian. This should be clearly distinguished from passengers/persons riding on vehicle 2 and vehicle 3. The operation of recognizing passengers C, D, E and F as pedestrians and transmitting a warning message so as to give a warning message to the corresponding UE should be regarded as a wrong operation. If it is assumed that the situation (passenger (i.e., location except for the vehicle), information on whether there is a passenger in the vehicle, riding on a vehicle on a land of the opposite side (or a location within the vehicle), a cell connected by the UE and the like) faced by the UE in various situations are UE conditions, such conditions should be clearly classified. For accurate classification, the following methods may be applied.

Hereinafter, the UE includes a V2P device, a D2D UE, etc. Further, particularly in the case that a UE mounted on or installed in a vehicle and a UE held by a user are separately described, the UE will be called a vehicle UE or a UE of user, but in other cases, the UE includes both the vehicle terminal and the UE of user.

Further, even if there is no specific description on the method of transmitting a D2D discovery signal (i.e., PSDCH) or D2D direct communication control information (i.e., PSCCH)/data (i.e., PSSCH), the method described in FIGS. 10 to 14 may be applied in the same manner.

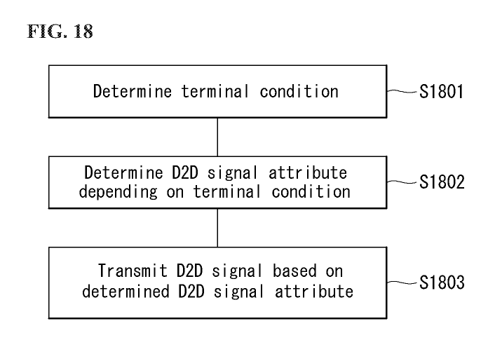

FIG. 18 illustrates a D2D communication method based on a UE condition according to an embodiment of the present invention.

FIG. 18 illustrates a flowchart in aspect of a UE transmitting a D2D signal.

Referring to FIG. 18, the UE determines the UE condition of the UE (S1801).

Here, from the perspective of the UE transmitting a D2D signal, the UE condition means a situation faced by the corresponding UE. For example, the UE condition may mean whether the user of the UE is a current pedestrian, whether the user of the UE has ridden in a vehicle, whether the UE is currently connected to a certain cell, etc. The details about the UE condition will be described later.

The UE determines D2D signal attributes depending on the UE condition (S1802).

Here, the D2D signal means the channel and/or signal of the link (i.e., a sidelink) which is used for inter-UE direct communication and discovery. Some examples of the sidelink channel are PSSCH, PSCCH, PSDCH, and/or PSBCH. Further, some examples of the sidelink signal include a demodulation reference signal, a D2D synchronization signal (i.e., a PSSS and/or a SSSS).

The D2D signal attribute means the attribute of the channel and/or signal for identifying the UE conditions such as the mapping resource of the sidelink channel and/or sidelink signal, the message content, the structure/sequence index of the hopping pattern and/or signal, etc. and includes one or more of the above attributes. The details about the D2D signal attribute will be described later.

The UE transmits a D2D signal based on the determined D2D signal attribute (S1803).

Hereinafter, the case that the UE condition indicates whether the UE user has ridden in a vehicle is assumed in the description for the convenience of description, but the present invention not limited thereto.

First, as shown in step S1801 of FIG. 18, in the case of the UE of the user having ridden in a vehicle, information on whether the user has ridden in the vehicle (i.e., UE condition) should be recognized in advance, and the UE may be recognized in the following methods.

1) Various sensors mounted on a vehicle may be utilized.

For example, various sensors mounted on a vehicle may sense that the UE of user has approached and the vehicle UE may transmit the sensed signal to the UE of user.

Further, various sensors mounted on the UE may also be utilized. For example, the sensor mounted on the UE may sense that the current user has ridden in the vehicle and the UE may sense the riding based thereon.

2) Further, the UE may be set to recognize the riding on the vehicle through the contact or communication reception using communication schemes such as the NFC tag, Bluetooth, wireless local area network (WLAN) (WiFi), Zigbee, etc.

For example, the UE may generate and output a wireless frequency field (or signal) by performing a polling, and if a response signal to the corresponding wireless frequency field is received from the corresponding NFC tag by the UE's approach to the NFC tag attached on the vehicle (or vehicle UE), the UE may recognize that the user has ridden in the vehicle.

3) Further, it is possible for the UE to manually set whether the user has ridden in the vehicle. For example, the UE may recognize that the user has ridden in the vehicle by receiving an input signal from the user.

4) Further, information on whether the user has ridden in the vehicle may be checked by paring with a wireless LAN device (e.g., a vehicle UE) mounted in a vehicle.

For example, if the association procedure defined in IEEE 802.11 between the wireless LAN device (e.g., vehicle UE) mounted on the vehicle and the UE is successfully performed, the UE may recognize that the user has ridden in a vehicle. Through such an association procedure, the UE may be allocated an identifier (e.g., an association identifier (AID) for identifying the corresponding UE within the service coverage of the wireless LAN device).

5) Further, the LTE small cell (e.g., a v-cell (vehicle cell)) base station may also check the riding on the vehicle. Here, particularly when the vehicle UE installed in or mounted on the vehicle performs the function of a small cell, it may be called a v-cell. Hereinafter, it is commonly called a small cell.

For example, when a user rides in a vehicle, if the UE attempts to connect to a vehicle base station (e.g., the vehicle UE performs the function of the base station) and succeeds in the connection, the UE may recognize that the user has ridden in the vehicle. For example, the connection to the v-cell of the vehicle through the PRACH procedure (i.e., the random access procedure illustrated in FIGS. 8 and 9) defined in the 3GPP LTE/LTE-A system is possible. Through such an association procedure, the UE may be allocated an identifier (e.g., C-RNTI, SL (sidelink)-RNTI, etc.) for identifying the corresponding UE within the service coverage of the corresponding v-cell.

However, when there is another vehicle in a short distance, a multitude of v-cells may be detected. Further, when determining whether the user has ridden in the vehicle using the communication scheme such as the vehicle UE and WLAN, etc., a multitude of wireless LAN devices may also be detected if there is another vehicle in a short distance.

In the case of the v-cell, for example, recommending a v-cell with the highest signal intensity and showing the list to the user, and finally letting the user himself to make a choice from the list may be a complementary method. Namely, the method of automatic selection in the UE may become a threatening element in the future safety, and thus it may be safer to directly get confirmation from the user, which will be described later with reference to the drawings.

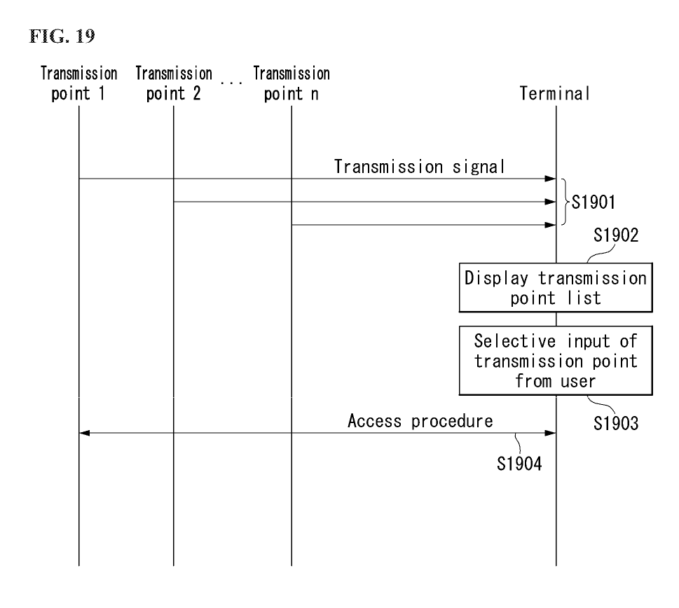

FIG. 19 illustrates a D2D communication method based on a UE condition according to an embodiment of the present invention.

Referring to FIG. 19, transmission points (TP) 1 to n transmit (e.g., broadcast) a transmission signal to the UE (S1901). Namely, the UE receives a transmission signal which is transmitted from the neighbor TP.

Here, the transmission point corresponds to the UE, a small cell (e.g., a v-cell), or the base station which is installed or mounted in the vehicle.

Here, an example of the transmission signal may include a synchronization signal (PSS and/or SSS) defined in the 3GPP LTE/LTE-A system, a synchronization signal for D2D communication, or a beacon signal defined in the 802.11 WLAN system. For example, the synchronization signal may be scrambled with a sequence generated based on the unique identifier (e.g., a cell ID) of the transmission point and transmitted, and the beacon signal may include, for example, a basic service set identifier (BSSID).

The UE displays the transmission point list based on the intensity of the transmission signal (S1902).

Namely, the UE may identify the transmission point having transmitted each transmission signal and display the corresponding transmission point list as described above.

Here, the UE may display the transmission point with the highest transmission signal intensity as described above. Further, the UE may arrange and display the list of the transmission points in the order that the intensity of the transmission signal gradually decreases. Further, the UE may display the list of n transmission points with the highest transmission signal intensity (for example, the transmission points may be arranged in the order of the transmission signal intensity or displayed with the transmission signal).

At this time, when the transmission point (particularly, v-cell) list is displayed, it is preferred that the list of the transmission points is shown in the form of the vehicle's unique ID. A vehicle number may be used as an example of the vehicle's unique ID. It is because in this case, the list of vehicle numbers is displayed as the vehicle's unique ID and the user directly compares the user's vehicle number so as to confirm whether the vehicle number coincides with the vehicle the user tries to ride in.

The UE receives a selection input of the transmission point from the user (S1903).

If the final selection is not received from the user, the selection may be automatically determined in another way. For example, when the vehicle UE and the UE of user are maintained for more than a prescribed amount of time, this may be regarded as a situation of riding in the vehicle. Namely, if the signal received from the neighbor UE is maintained for a prescribed time with a prescribed intensity, the UE may determine that the user has ridden in the vehicle. Further, the information on whether the user has ridden in the vehicle may be registered by paring the corresponding vehicle UE with the UE of user. In this case, step S1903 may be omitted.

The UE performs an access procedure with the transmission point having maintained a prescribed time with a constant signal intensity or transmission point selected from the user (assuming transmission point 1 in FIG. 19) (S1904).

Here, as an example of the access procedure, the PRACH procedure defined in the 3GPP LTE/LTE-A system, etc. (i.e., a random access procedure illustrated in FIG. 8 and FIG. 9) may be used. Further, the association procedure defined in 802.11 WLAN system may be used.

Likewise, the user riding in each vehicle should be at a state which is distinguished from the pedestrian (e.g., an on-boarding status). Namely, the UE of the user having ridden in the vehicle recognizes the state that the user has ridden in the vehicle.

Meanwhile, the embodiment of determining the UE condition has been separately described, but one or more embodiments may be combined in order to determine the UE condition.

Further, as in step S1802 of FIG. 18, the UE of the user having ridden in the vehicle enables information indicating the UE condition (e.g., the boarding state of the user) in the D2D signal (i.e., the sidelink channel and/or signal) which is to be transmitted (unicast, multicast, or broadcast) later and transmits the D2D signal.

To this end, attributes of the D2D signal such as the sequence index (e.g., the sequence index of the synchronization signal, the sequence index of the demodulation reference, the scrambling sequence index of PSDCH/PSSCH/PSCCH/PSBCH, etc.), the resource area where the D2D signal is mapped (time, frequency and/or space resource area), the message content of the D2D signal (e.g., the content carried in PSDCH/PSSCH/PSCCH/PSBCH, etc.), the hopping pattern (e.g., time and/or frequency hopping pattern) of the D2D signal, the structure/sequence index of the reference signal related to the D2D signal (e.g., the structure/sequence index, etc. of the synchronization signal and/or demodulation reference signal), etc. are distinguished depending on the boarding state of the user. Here, the examples of the structure of the reference signal may include the frequency/time resource to which the reference signal is mapped and the transmission cycle of the reference signal.

Specifically, the examples are as follows.

a) A specific bit value may be differently set to the content (e.g., the content transmitted in PSDCH/PSSCH/PSCCH/PSBCH, etc.) of the D2D signal.

For example, when 1 bit is used, boarding ON/OFF may be expressed. As another example, 2 or more bits may also be reserved in order to express the case of a situation other than the boarding situation. In this case, the bit setting of the bit field should be predetermined depending on the situation.

As another example, when 2 bits are used, “00-pedestrian”, “01-pessenger”, “10-reserved”, “11-reserved”. The reserved state means being set according to another situation to be added later.

b) Further, the set of the sequences (e.g., the synchronization signal sequence, the sequence of the demodulation reference signal, the scrambling sequence of PSDCH/PSSCH/PSCCH/PSBCH, etc.) of a plurality of D2D signals may be separately defined.

For example, a specific sequence set may be allocated to the pedestrian, another sequence set may be allocated to the passenger, and further another sequence set may be allocated for another purpose. Further, the UE may use a sequence selected from a specific sequence set depending on the UE condition of the UE.

c) Further, as the simplest method, the UE ID may be set to a specific ID depending on the UE condition. Namely, the UE ID (set) is separately defined depending on the UE condition, and the UE may use the UE ID selected within the UE ID set which fits the UE condition of the UE. Further, the selected UE ID may be included in the D2D signal.

Here, the examples of the UE ID may include a SL-RNTI (sidelink-RNTI) used for a direct communication scheduling, a source layer-2 ID for identifying the data sender within direct communication, a discovery ID for identifying the transmitter for transmitting a discovery signal, and a scrambling ID of the sequence of the signal such as a synchronization signal or a demodulation reference signal.

For example, the UE ID may be included in the content transmitted in PSDCH/PSSCH/PSCCH/PSBCH (in the case of PSDCH, the discovery message, in the case of PSCCH, sidelink control information (SCI), in the case of PSSCH, direct communication data, and in the case of PSBCH, system and synchronization-related information) and transmitted. Further, when the scrambling sequence of the content transmitted in PSDCH/PSSCH/PSCCH/PSBCH is generated, a scrambling sequence may be generated based on the UE ID. Further, when the sequence of the synchronization signal/demodulation reference signal is generated, the sequence of the synchronization signal/demodulation reference signal may be generated based on the UE ID.

Further, when the user (or UE) may be allocated one or more UE IDs, the method of selecting and using depending on the boarding state per UE ID may be applied. For example, one UE may be set one UE ID in the UE ID (set) used by the passenger and one UE ID in the UE ID (set) used by the pedestrian, and the UE ID may be selectively used depending on the UE condition.

Further, when the user (or UE) may be allocated one or more UE IDs, the UE condition may be expressed by combining two UE IDs. Particularly, the UE ID1 and UE ID2 may be FDM-multiplexed in the frequency domain or TDM-multiplexed while interlacing in a specific pattern according to time in the method of combination. Namely, the multiplexing pattern in the frequency or time domain of D2D signals including each UE ID may be determined depending on the UE condition.

Expressing different UE conditions with the multiplexing pattern in such a time or frequency domain may be one way to efficiently use the limited UE ID.

In this case, different UE conditions may be specified depending on the pattern in which combined discovery signals (i.e., UE IDs) and/or corresponding discovery signals (i.e., UE IDs) are multiplexed in the time domain or frequency domain.

d) There is a method of combining the vehicle's unique ID (e.g., the vehicle number) (or cell ID) together with the above c) method. Namely, this is a method of combining vehicle ID with UE ID so as to generate a combined ID and transmit the generated ID in the D2D signal.

Likewise, if the vehicle ID is combined with the UE ID to be transmitted, information on whether the D2D UE user has boarded on a vehicle and the vehicle on which the user has boarded may be identified in the receiving UE.

At this time, the vehicle ID may be obtained from the vehicle ID during the process of performing an access to the vehicle UE (e.g., a random access procedure or an association procedure, etc.). Further, a vehicle may have been registered in the UE in advance.

Likewise, by indicating not only information that the user has boarded on a vehicle but also on which vehicle the user has boarded, neighbor UEs (e.g., neighbor V2P/D2D devices) are helped to more accurately recognize the situation. For example, in the case of two neighboring moving vehicles (in the above example, vehicle 1 and vehicle 2 are adjacently moving), it is difficult to know the vehicle on which A, B, C and D have boarded, except for the information that all of A, B, C and D have boarded on a vehicle. However, if the UE ID and the vehicle ID are combined to be used, it is possible to know the vehicle on which each user has boarded in the neighbor UE.

Such information on the vehicle on which the user has boarded may be used to prevent a crime. For example, when a user boards on a vehicle such as a taxi, whether a passenger has boarded on a specific taxi is automatically determined, and the taxi's unique information and the passenger's taxi's unique information are combined, and the UE broadcasts a discovery signal based thereon (or broadcasts in the form of a message through a direct communication channel (i.e., PSCCH/PSCCH)) so that the neighbor UEs may recognize the situation, thereby preventing a crime, which may be applicable to a safe taxi service, etc. Further, when applied to the service above-described with reference to FIGS. 12 to 14, information on whether a person has boarded on a vehicle may be stored as a record and later may be used for the purpose of providing a clue for solving a crime through a log analysis.

Meanwhile, as described above, when a vehicle UE functions as a LTE small cell, the above-described ID may be understood as cell ID. In this case, the combination of the vehicle ID and the UE ID may also be understood to mean the combination of cell ID connected by the UE and UE ID.

An example of a method of combining vehicle ID with UE ID (or cell ID or UE ID) includes generating one new combined ID by connecting vehicle ID with UE ID. Further, one new combined ID may be generated by truncating a part of vehicle ID and a part of UE ID and concatenating the truncated parts. Further, it may be generated by masking with another ID in the CRC (Cyclic Redundancy Check) of one ID among vehicle ID and UE ID. Further, the combined ID may be generated by bit level operation (e.g., XOR operation) of vehicle ID and UE ID. Further, the combined ID may be generated by utilizing a part of the whole of one of vehicle ID and UE ID as the seed of another ID generation.

Likewise, as described above, the generated, combined ID may be transmitted in the content of the D2D signal, may be used when generating the scrambling sequence of the content of the D2D signal, or may be used when generating the sequence of the D2D signal.

Yet, the present invention is not limited to the method of combining the above-illustrated UE ID with UE ID (or cell ID).

Both UE ID and vehicle ID (or cell ID) are used together for D2D signal transmission, but they are not generated as one new combined ID but are individually used so as to specify the UE condition.

For example, the UE ID and the vehicle ID (or cell ID) are transmitted together to the content of the D2D signal, the vehicle ID (or cell ID) is used together with the UE ID when generating the scrambling sequence of the content of D2D signal, or the vehicle ID (or cell ID) may be used with the UE ID when generating the sequence of D2D signal.

Further, the UE condition may be specified by combining D2D signal transmitting vehicle ID (or cell ID) with D2D signal transmitting UE ID. In this case, the receiving UE may receive both D2D signal transmitting UE ID (or cell ID) and D2D signal transmitting UE ID so as to determine the UE condition of the transmitting UE of the corresponding D2D signal.

For example, the sequence of the demodulation reference signal transmitted for demodulation of PSSCH may be generated based on vehicle ID (or cell ID), and the content transmitted to PSDCH/PSCCH/PSSCH may be scrambled in the scrambling sequence generated based on UE ID or transmitted including UE ID. In this case, the receiving UE may identify the UE condition of the transmitting UE using PSDCH/PSCCH/PSSCH and the demodulation reference signal related to the PSDCH/PSCCH/PSSCH.

Further, the sequence of the synchronization signal may be scrambled with the vehicle ID (or cell ID), and the content transmitted to PSDCH/PSCCH/PSSCH/PSBCH may be scrambled with the scrambling sequence generated based on the UE ID. In this case, the receiving UE may identify the UE condition of the transmitting UE using a synchronization signal and PSDCH/PSCCH/PSSCH/PSBCH which is transmitted in the UE having transmitted the corresponding synchronization signal.

What is important here is that being able to reverse-extract vehicle information from such generated new information (i.e., new UE ID) and boarded user information needs a requirement.

Meanwhile, various embodiments for determining the message attribute according to the UE condition have been separately described above, but one or more embodiments may be combined to determine the UE condition.

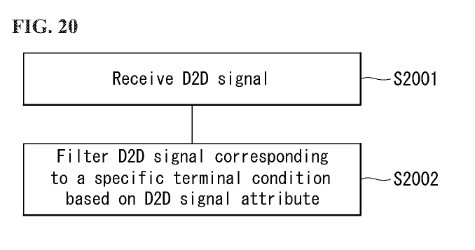

FIG. 20 illustrates a D2D communication method based on the UE condition according to an embodiment of the present invention.

FIG. 20 illustrates a flowchart in aspect of a UE receiving a D2D signal.

Referring to FIG. 20, the UE receives a D2D signal transmitted from a neighbor UE (S2001).

Here, from the perspective of a UE receiving a D2D signal, the UE condition means a situation faced by a UE having transmitted the corresponding D2D signal. For example, the UE condition may mean whether the user of the UE is currently a pedestrian, whether a person has boarded on a vehicle, whether a person has boarded on a vehicle moving on a lane of the opposite side, whether a person has boarded on a vehicle in the front or at the back of the vehicle on which a person has boarded, the cell to which the corresponding UE is currently connected, and the like. The details about the UE condition will be described later.

The UE filters a D2D signal according to a specific UE condition based on the D2D signal attribute of the received D2D signal (S2002).

While the receiving UE performs a search of a pedestrian which is the object of the V2P service of a vehicle, if the receiving UE recognizes that the user of the transmitting UE is recognized the vehicle-boarding based on the D2D signal attributes, the corresponding transmitting UE (i.e., the passenger) may be automatically exempted from the searched objects.

In the above description, from the perspective of vehicle 1, nearby A, B, C, D, E, F and P are searched as the potential V2P service object UE, but because A, B, C, D, E and F have received a message or signal for checking the boarding on the vehicle, the operation of exemption from the V2P service list is required. Such an operation may be regarded as a kind of filtering.

Likewise, due to a filtering operation, it is effective in reducing a processing consumed in tracing continually potential V2P UEs. Since such information on the boarding is not frequently changed, information on the boarding is reported to a specific server (e.g., M2M server; see FIG. 1) through the LTE network and this information is continually updated and reported to a vehicle providing a V2P service, and thus exemption from the V2P safety service monitoring object is performed.

General Wireless Communication to which the Present Invention is Applicable

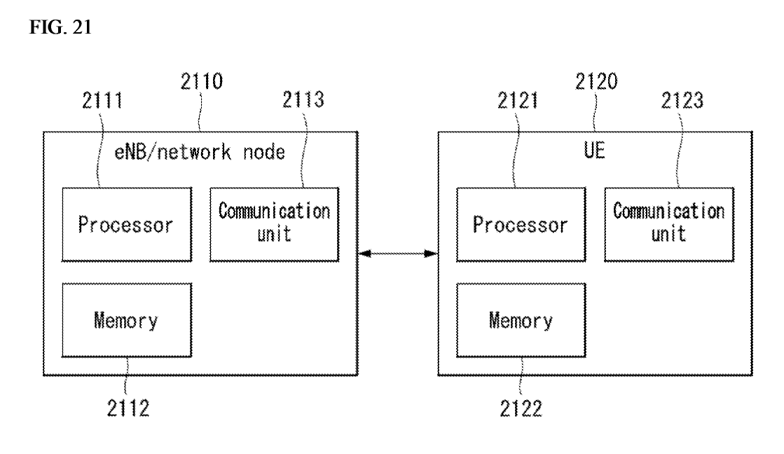

FIG. 21 illustrates a block diagram of a wireless communication apparatus according to an embodiment of the present invention.

Referring to FIG. 21, a wireless communication system includes a base station (BS)/network node 2110 and a multitude of UEs 2120 (D2D UE and/or V2P device). Here, the network node may include MME or M2M server.

The BS/network node 2110 includes a processor 2111, a memory 2112, and a communication unit 2113.

The processor 2111 implements the function, process, and/or method proposed in FIGS. 1 to 20. The layers of wired/wireless interface protocols may be implemented by the processor 2111. The memory 2112 may be connected to the processor 2111 so as to store various informations in order to drive the processor 2111. The communication unit 2112 may be connected to the processor 2111 so as to transmit and/or receive a wired/wireless signal. Particularly, when the BS/network node 2110 is a BS, the communication unit 2113 may include an RF (radio frequency) unit for transmitting/receiving a wireless signal.

The UE 2120 includes a processor 2121, a memory 2122, and a communication unit (or RF unit) 2123. The processor 2121 implements the function, process and/or method proposed in FIGS. 1 to 20. The layers of the wireless interface protocol may be implemented by the processor 2121. The memory 2122 may be connected to the processor 2121 so as to store various informations for driving the processor 2121. The communication unit 2123 is connected to the processor 2121 so as to transmit/or receive a wireless signal.

The memories 2112 and 2122 may be inside or outside processors 2111 and 2121 and may be connected to the processors 2111 and 2121 by well-known various means. Further, when the BS/network node 2110 is a BS, the UE 2120 may include a single antenna or a multiple antenna.

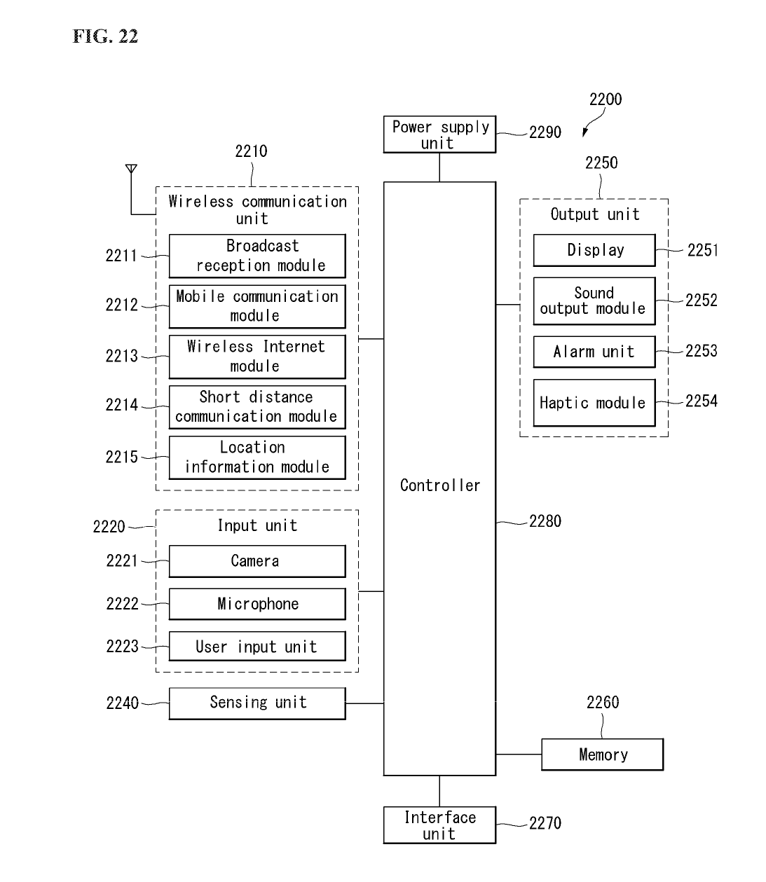

FIG. 22 is a block diagram of a UE according to another embodiment of the present invention.

Referring to FIG. 22, a UE 2200 includes a wireless communication unit 2210, an input unit 2220, a sensing unit 2240, an output unit 2250, a memory 2260, an interface unit 2270, a controller 2280, and a power supply unit 2290. Since the components illustrated in FIG. 22 are not essential, more or less components may be used to implement a mobile UE.

Hereinafter, the above components are described.

The wireless communication unit 2210 may include one or more modules which enable wireless communication between the UE 2200 and a wireless communication system or between the UE 2200 and a network where the UE 2200 is located. For example, the wireless communication unit 2210 may include a broadcast receiving module 2211, a mobile communication module 2212, a wireless Internet module 2213, a short distance communication module 2214, and a location information module 2215.

The broadcast receiving module 2211 receives a broadcast signal and/or broadcast-related information from an external broadcast management server through a broadcast channel.

The broadcast channel may include a satellite channel and a ground wave channel. The broadcast management server may mean a server which generates and transmits a broadcast signal and/or broadcast-related information or a server which is provided already generated broadcast signal and/or broadcast-related information and transmits the broadcast signal and/or the broadcast-related information to the UE. The broadcast signal may include not only a TV broadcast signal, a radio broadcast signal, and a data broadcast signal but also a broadcast signal in the form of the combination of a TV broadcast signal or a radio broadcast signal and a data broadcast signal.

The broadcast-related information may mean information related to a broadcast channel, a broadcast program, or a broadcast service provider. The broadcast-related information may be provided also through a mobile communication network. In such a case, the information may be received by the mobile communication module 2212.

The broadcast-related information may exist in various forms. For example, the information may exist in the form of ESG (Electronic Service Guide), etc. of EPG (Electronic Program Guide) or DVB-H (Digital Video Broadcast-Handheld) of DMB (Digital Multimedia Broadcasting).

For example, the broadcast receiving mode 2211 may receive a digital broadcast signal using a digital broadcast signal such as DMB-T (Digital Multimedia Broadcasting-Terrestrial), DMB-S (Digital Multimedia Broadcasting-Satellite), MediaFLO (Media Forward Link Only), DVB-H (Digital Video Broadcast-Handheld), ISDB-T (Integrated Services Digital Broadcast-Terrestrial) or the like. Here, the broadcast receiving module 2211 may be formed to fit other broadcast systems as well as the above-described digital broadcast system.

The broadcast signal and/or broadcast-related information received through the broadcast receiving module 2211 may be stored in the memory 2260.

The mobile communication module 2212 transmits/receives a wireless signal with at least one of the base station, an external UE, and a server. The wireless signal may include data of various forms according to transmission/reception of a voice call signal, a video call signal, or a text/multimedia message.

The wireless Internet module 2213 means a module for wireless Internet access and may be mounted inside or outside the UE 2200. WLAN (Wireless LAN) (Wi-Fi), Wibro (Wireless broadband), Wimax (World Interoperability for Microwave Access), HSDPA (High Speed Downlink Packet Access) or the like may be used the wireless Internet technology.

The short distance communication module 2214 means a module for short distance communication. Bluetooth, RFID (Radio Frequency Identification), IrDA (infrared Data Association), UWB (Ultra Wideband), ZigBee or the like may be used as the short range communication technology.

The location information module 2215 is a module for obtaining the location of a mobile UE and the representative example thereof is a GPS (Global Position System) module.

The input unit 2220 is for an audio signal or video signal input or a user input. The camera 2221 or the microphone 2222 may be included for the audio signal or video signal input.

The camera 2221 processes an image frame such as a still image, a moving image or the like which is obtained by an image sensor in a video call mode or a photographing mode. The processed image frame may be displayed on the display unit 2251.

The image frame processed in the camera 2221 may be stored in the memory 2260 or may be transmitted to the outside through the wireless communication unit 2210. Two or more cameras 2221 may be used depending on the use environment.

The microphone 2222 receives an input of an external sound signal by the microphone in a calling mode, a recoding mode, a voice recognition mode or the like so as to be processed as electric voice data. The processed voice data may be converted into a transmittable form through the mobile communication module 2212 and be outputted to the mobile communication base station. Various noise-removing algorithms for removing the noise generated in the process of receiving the input of an external sound signal may be implemented.

The user input unit 2223 generates an input data for operation control of the UE by the user. The user input unit 130 may be formed as a key pad dome switch, a touch pad (static voltage/static current), a jog wheel, a jog switch or the like.

The sensing unit 2240 generates a sensing signal for controlling the operation of the UE 2200 by sensing the current state of the UE 2200 such as the open/close state of the UE 2200, the location of the UE 2200, the contact state of the user, the direction of the UE, and acceleration/deceleration of the UE or the like. For example, when the UE 2200 is in the form of a slide phone, the open/close state of the slide phone may be sensed. Further, the power supply state of the power supply unit 2290 and the external device coupling state of the interface unit 2270 or the like may also be sensed. Further, the sensing unit 2240 may include a proximity sensor, a sensor capable of sensing the heart rate, the pulse breathing, blood pressure and the like of the user of the UE 2200, and a sensor capable of the temperature, noise, and the like near the UE 2200.

The output unit 2250 is for generating an output related to a visual sense, an auditory sense, a tactile sense or the like and may include a display unit 2251, a sound output module 2252, an alarm unit 2253 and a haptic module 2254.

The display unit 2251 displays information processed in the UE 2200. For example, when the mobile UE is in a calling mode, a UI (User Interface) or a GUI (Graphic User Interface) related to the calling is displayed. When the UE 2200 is in a video calling mode or a photographing mode, the photographed and/or received image or UI, GUI or the like are displayed.

The display unit 2251 may include at least one of a liquid crystal display (LCD), a thin film transistor-liquid crystal display (TFT LCD), an organic light-emitting diode (OLED), a flexible display, and a 3D display.

Among them, some displays may be configured as a transparent or light-transmitting type in order to see the external side through such displays. Each of such displays may be called a transparent display, and a representative example of the transparent display is a transparent OLED (TOLED). The rear structure of the display unit 2251 may also be formed as a light-transmitting structure. By such a structure, the user may see an object located in the backside of the UE body through an area occupied by the display unit 2251 of the UE body.

There may be two or more display units 2251 depending on the form of implementation of the UE 2200. For example, a plurality of display units may be arranged on one surface in a manner that is separated from each other or integrally or may be respectively arranged on different surfaces.

When a sensor (hereinafter, “touch sensor”) sensing the display unit 2251 and the touch operation forms a mutual layer structure (hereinafter, “touch screen”), the display unit 2251 may also be used as an input device as well as an output device. For example, the touch sensor may include the form of a touch film, a touch sheet, a touch pad or the like.

The touch sensor may be configured to convert a change of the pressure applied to a specific region, a capacitance generated in a specific region of the display unit 2251, or the like into an electric input signal. The touch sensor may be configured to detect the pressure at the time of a touch as well as the touched location and area size.

When there is a touch input on the touch sensor the corresponding signals are sent to a touch controller. The touch controller processes the signals and transmits the corresponding data to the controller 2280. As such, the controller 2280 may know which area of the display unit 2251 has been touched.

The proximity sensor may be arranged at the inner area of the mobile UE which is covered by the touch screen or a location near the touch screen. The proximity sensor means a sensor which detects whether there is an object approaching a predetermined detection surface or an object existing in the vicinity using the electromagnetic field or infrared rays without a mechanical contact. The lifespan is longer than the contacting sensor and the utilization level is high.

Some examples of the proximity sensor include a transmission type photoelectric sensor, a direct reflection type photoelectric sensor, a mirror reflection type photoelectric sensor, a high frequency launching type proximity sensor, a capacitance type proximity sensor, a magnetic type proximity sensor, an infrared ray proximity sensor and the like. When the touch screen is an electrostatic type, the touch screen is configured to detect the approach of the pointer by the change of the electric field according to the approach of the pointer. In this case, the touch screen (touch sensor) may be classified as the proximity sensor.

In the aforementioned embodiments, the elements and characteristics of the present invention have been combined in specific forms. Each of the elements or characteristics may be considered to be optional unless otherwise described explicitly. Each of the elements or characteristics may be implemented in such a way as to be not combined with other elements or characteristics. Furthermore, some of the elements and/or the characteristics may be combined to form an embodiment of the present invention. The order of the operations described in connection with the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

An embodiment of the present invention may be implemented by various means, for example, hardware, firmware, software or a combination of them. In the case of implementations by hardware, an embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers and/or microprocessors.

In the case of an implementation by firmware or software, an embodiment of the present invention may be implemented in the form of a module, procedure, or function for performing the aforementioned functions or operations. Software code may be stored in memory and driven by a processor. The memory may be located inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

A UE-condition based D2D communication scheme in a wireless communication system according to the present invention was described centering on an example applicable to 3GPP LTE/LTE-A system, but the scheme may also be applied to various wireless communication systems as well as the 3GPP LTE/LTE-A system.

1. A method of performing, by a user equipment (UE), a Device to Device (D2D) communication based on a UE condition in a wireless communication system supporting the D2D communication, the method comprising:
determining, by the UE, a UE condition indicating a situation faced by the UE;
determining an attribute of a D2D signal depending on the UE condition; and
transmitting the D2D signal based on the attribute of the D2D signal.

2. The method of claim 1, wherein the UE condition comprises whether a user of the UE is in an on-boarding status.

3. The method of claim 2, wherein if a random access procedure with the UE mounted on the vehicle is successfully completed, it is determined that the user is in the on-boarding status.

4. The method of claim 2, further comprising displaying, based on an intensity of a signal received from a UE mounted on a neighbor vehicle, a list of UEs having transmitted the signal,
wherein if the UE receives a selection of a specific UE from a list of the UEs from the user, it is determined that the user is in the on-boarding status on the vehicle having the selected UE mounted thereon.

5. The method of claim 2, wherein if a signal received from a UE mounted on a neighbor vehicle is maintained with a predetermined intensity for a predetermined time, it is determined that the user is in the on-boarding status on the vehicle having the UE having transmitted the signal mounted thereon.

6. The method of claim 1, wherein the attribute of the D2D signal includes at least one selected from the group consisting of a sequence index of the D2D signal, a resource area to which the D2D signal is mapped, a message content of the D2D signal, a hopping pattern of the D2D signal, a structure of sequence of a reference signal related to the D2D signal, or a sequence of a reference signal related to the D2D signal.

7. The method of claim 1, wherein a sequence set of different D2D signals is defined per UE condition, and a sequence of the D2D signal is selected within a specific sequence set corresponding to the UE condition.

8. The method of claim 1, wherein a different UE identifier (ID) set is defined per UE condition, and a UE ID selected within a specific UE ID set corresponding to the UE condition is included in the D2D signal and transmitted.

9. The method of claim 8, wherein when the UE is allocated a plurality of UE IDs, a specific UE ID is selected from the allocated plurality of UE IDs depending on the UE condition.

10. The method of claim 8, wherein when the UE is allocated a plurality of UE IDs, a multiplexing pattern in a frequency or time domain of D2D signal including each UE ID depending on the UE condition is determined.

11. The method of claim 8, wherein when the user of the UE is in an on-boarding status, a combination ID of the selected UE ID and a vehicle ID is included in the D2D signal and transmitted.

12. The method of claim 11, wherein the combined ID is generated by a connection of the UE ID and the vehicle ID, by a connection of a part of the UE ID and a part of the vehicle ID, by masking a Cyclic Redundancy Check (CRC) of either the UE ID or the vehicle ID with a different ID, by bit operation of the UE ID and the vehicle ID, or by using a part or a whole of either the vehicle ID or the UE ID as a seed of another ID generation.

13. A user equipment (UE) for performing a Device to Device (D2D) communication in a wireless communication system supporting the D2D communication, the UE comprising:
a radio frequency (RF) unit for transmitting/receiving a wireless signal; and
a processor,
wherein the processor is configured to:
determine a UE condition indicating a situation faced by the UE;
determine an attribute of a D2D signal depending on the UE condition; and
transmit the D2D signal based on the attribute of the D2D signal.
